(19) United States
(12) Patent Application Publication
(10) Pub. No.: US 2022/0108693 A1
(43) Pub. Date: Apr. 7, 2022

(54) RESPONSE PROCESSING DEVICE AND RESPONSE PROCESSING METHOD

(71) Applicant: SONY GROUP CORPORATION, TOKYO (JP)

(72) Inventors: YOSHINORI MAEDA, TOKYO (JP); NORIKO TOTSUKA, TOKYO (JP); CHIE KAMADA, TOKYO (JP); YUKI TAKEDA, TOKYO (JP); KAZUYA TATEISHI, TOKYO (JP); YUICHIRO KOYAMA, TOKYO (JP); EMIRU TSUNOO, TOKYO (JP); AKIRA TAKAHASHI, TOKYO (JP); HIDEAKI WATANABE, TOKYO (JP); AKIRA FUKUI, TOKYO (JP); KAN KURODA, TOKYO (JP); HIROAKI OGAWA, TOKYO (JP)

(21) Appl. No.: 17/309,983

(22) PCT Filed: Nov. 29, 2019
(86) PCT No.: PCT/JP2019/046876

§ 371 Date: Jul. 7, 2021

(30) Foreign Application Priority Data
Jan. 16, 2019 (JP) 2019-005559

(51) Int. Cl. G10L 15/22; G06F 3/16; G06F 3/14

(52) U.S. Cl. CPC G10L 15/22; G10L 2015/223; G06F 3/14; G06F 3/167

(57) ABSTRACT

A response processing device includes a reception unit configured to receive input information being information that triggers generation of a response by an information device, a presentation unit configured to present to a user each of the responses generated by a plurality of the information devices for the input information, and a transmission unit configured to transmit user's reaction to the presented responses, to the plurality of information devices. For example, the reception unit receives the voice information from the user, as the input information.

### FIELD

The present disclosure relates to a response processing device and a response processing method. More specifically, the present disclosure relates to response processing for a user who uses a plurality of information devices.

### BACKGROUND

With the progress of network technology, users have increasing opportunities to use a plurality of information devices. In view of such a situation, technology for smoothly utilizing the plurality of information devices has been proposed.

For example, a technique has been proposed for efficiently performing processing of the whole of a system by providing a device configured to integrally control the system, in the system in which a plurality of client devices is connected via a network.

### CITATION LIST

### Patent Literature

Patent Literature 1: JP H07-004882 A

### SUMMARY

### Technical Problem

According to the conventional art described above, the device configured to integrally control the system receives processing requests for the information devices and performs processing according to the functions of the individual information devices to efficiently perform processing for the whole of the system.

However, the conventional art cannot always improve the convenience of each user. Specifically, in the conventional art, it is only to determine whether the information devices can receive the processing requests and, for example, when each of the information devices receives a user's request and performs processing, the processing is not always performed in a manner to meet the user's request.

Therefore, in the present disclosure, a response processing device and a response processing method that are configured to improve the convenience of the user.

### Solution to Problem

According to the present disclosure, a processing device includes a reception unit configured to receive input information being information that triggers generation of a response by an information device; a presentation unit configured to present to a user each of the responses generated by a plurality of the information devices for the input information; and a transmission unit configured to transmit user's reaction to the presented responses, to the plurality of information devices.

### BRIEF DESCRIPTION OF DRAWINGS

FIG. 1 is a diagram illustrating a response processing system according to a first embodiment.

FIG. 2A is a diagram (1) illustrating an example of a response process according to the first embodiment.

FIG. 2B is a diagram (2) illustrating an example of the response process according to the first embodiment.

FIG. 2C is a diagram (3) illustrating an example of the response process according to the first embodiment.

FIG. 2D is a diagram (4) illustrating an example of the response process according to the first embodiment.

FIG. 3A is a diagram (1) illustrating a first variation of the response process according to the first embodiment.

FIG. 3B is a diagram (2) illustrating the first variation of the response process according to the first embodiment.

FIG. 3C is a diagram (3) illustrating the first variation of the response process according to the first embodiment.

FIG. 3D is a diagram (4) illustrating the first variation of the response process according to the first embodiment.

FIG. 4A is a diagram (1) illustrating a second variation of the response process according to the first embodiment.

FIG. 4B is a diagram (2) illustrating the second variation of the response process according to the first embodiment.

FIG. 5 is a diagram illustrating a third variation of the response process according to the first embodiment.

FIG. 6A is a diagram (1) illustrating a fourth variation of the response process according to the first embodiment.

FIG. 6B is a diagram (2) illustrating the fourth variation of the response process according to the first embodiment.

FIG. 7 is a diagram illustrating a configuration example of the response processing system according to the first embodiment.

FIG. 8 is a diagram illustrating an example of a user information table according to the first embodiment.

FIG. 9 is a diagram illustrating an example of an agent table according to the first embodiment.

FIG. 10 is a diagram illustrating an example of a command table according to the first embodiment.

FIG. 11 is a diagram illustrating an example of a history table according to the first embodiment.

FIG. 12A is a flowchart illustrating a process according to the first embodiment.

FIG. 12B is a block diagram illustrating a process according to the first embodiment.

FIG. 13 is a diagram illustrating an example of a response process according to a second embodiment.

FIG. 14 is a diagram illustrating a first variation of the response process according to the second embodiment.

FIG. 15 is a table illustrating an example of a database according to the second embodiment.

FIG. 16A is a diagram illustrating a second variation of the response process according to the second embodiment.

FIG. 16B is a diagram illustrating a third variation of the response process according to the second embodiment.

FIG. 17 is a hardware configuration diagram illustrating an example of a computer configured to achieve the functions of a response processing device.

### DESCRIPTION OF EMBODIMENTS

Embodiments of the present disclosure will be described below in detail with reference to the drawings. Note that in each of the following embodiments, the same portions are denoted by the same reference symbols, and a repetitive description thereof will be omitted.

Furthermore, the present disclosure will be described in the order of items shown below.

1. First Embodiment

1-1. Overview of response processing system according to first embodiment

1-2. Example of response process according to first embodiment

1-3. Variations of response process according to first embodiment

1-4. Configuration of response processing system according to first embodiment

1-5. Procedure of response process according to first embodiment

1-6. Modification of first embodiment

2. Second Embodiment

2-1. Example of response process according to second embodiment

2-2. Variations of response process according to second embodiment

3. Other embodiments

3-1. Variation of response output

3-2. Timing to transmit user's reaction

3-3. Device configuration

4. Effects of response processing device according to present disclosure

5. Hardware configuration

### 1. First Embodiment

### 1-1. Overview of Response Processing System According to First Embodiment

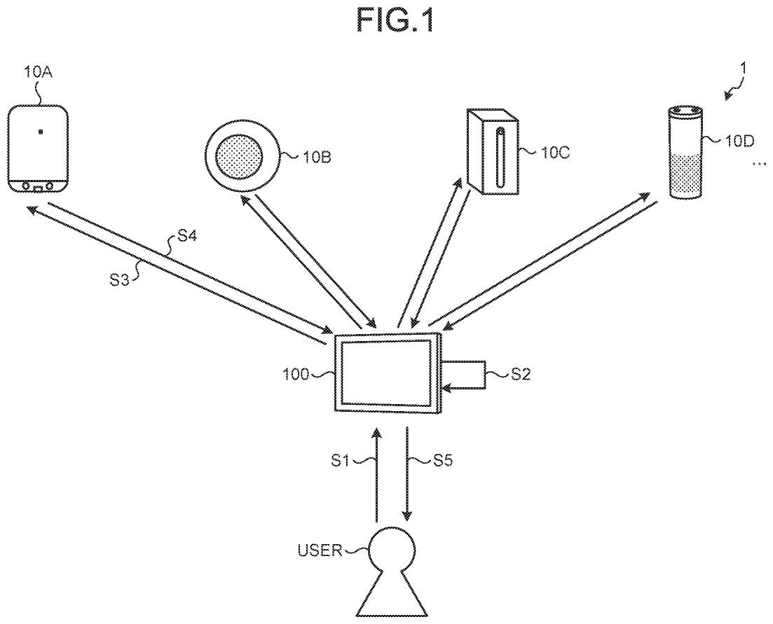

An overview of a response process according to a first embodiment of the present disclosure will be described with reference to FIG. 1. FIG. 1 is a diagram illustrating a response processing system 1 according to the first embodiment. Information processing according to the first embodiment is performed by a response processing device 100 illustrated in FIG. 1 and the response processing system 1 that includes the response processing device 100.

As illustrated in FIG. 1, the response processing system 1 includes the response processing device 100, an agent 10A, an agent 10B, an agent 10C, and an agent 10D. The devices included in the response processing system 1 are communicably connected via a wired or wireless network which is not illustrated.

The agent 10A, agent 10B, agent 10C, and agent 10D are devices each of which functions to have a voice conversation or the like with a user (referred to as agent function or the like) and perform various information processing such as voice recognition and response generation. Specifically, the agent 10A and the like are so-called Internet of Things (IoT) devices and each perform various information processing in cooperation with an external device such as a cloud server. In the example of FIG. 1, the agent 10A and the like are so-called smart speakers.

In the following, an agent function for learning about voice conversation and response and an information device that has the agent function are collectively referred to as “agent”. Note that the agent function includes not only a function executed by a single agent 10 but also a function executed on a server connected to the agent 10 via the network. In the following, when it is not necessary to distinguish individual information devices, such as the agent 10A, agent 10B, agent 10C, and agent 10D, the information devices are collectively referred to as “agents 10”.

The response processing device 100 is an example of a response processing device according to the present disclosure. For example, the response processing device 100 is a device configured to have a voice or text conversation with the user and perform various information processing such as voice recognition and generation of a response to the user. Specifically, the response processing device 100 performs the response process to information (hereinafter, referred to as “input information”) that triggers the generation of the response, such as a collected voice or a user's action. For example, the response processing device 100 recognizes a user's question and outputs an answer by voice to the question or displays information to the question on the screen. Note that various known techniques may be used for the processing of recognizing voice, outputting voice, and the like performed by the response processing device 100. Furthermore, the response processing device 100 coordinates the responses generated by the agents 10 and feedback to the agents 10, whose detailed description will be made later.

FIG. 1 illustrates an example in which the response processing device 100 is a so-called tablet terminal or smartphone. For example, the response processing device 100 includes a speaker unit configured to output voice and a display unit (liquid crystal display, etc.) configured to output video and the like. For example, the response processing device 100 performs the response process according to the present disclosure, on the basis of the function of a program (application) installed on the smartphone or tablet terminal. Note that the response processing device 100 may be a wearable device such as a watch terminal or glass terminal, in addition to the smartphone or tablet terminal. Furthermore, the response processing device 100 may be achieved by various smart devices having information processing functions. For example, the response processing device 100 may be a smart home appliance such as a TV, air conditioner, or a refrigerator, a smart vehicle such as an automobile, a drone, or an autonomous robot such as a pet robot or humanoid robot.

In the example illustrated in FIG. 1, the user uses the information device such as the agent 10A together with the response processing device 100. In other words, in the example of FIG. 1, it is assumed that the user is in an environment in which a plurality of the agents 10 is used.

As in the example illustrated in FIG. 1, there are various problems in appropriate operation in a situation where the plurality of the agents 10 is used by the user.

For example, the user needs to consider whether to use which agent 10 to perform what kind of process (i.e., whether to input what kind of input information into an agent 10) each time. Furthermore, when the user causes one agent 10 to perform a process and then causes the other agents 10 to perform the same process, the user needs to perform the same process repeatedly. Note that in the following, a request for causing the agent 10 to perform some kind of process on the basis of the input information from the user is referred to as a “command”. The command has, for example, a script indicating a user's question or the content of a request.

In addition, the agent 10 learns whether the user tends to ask what kind of question or tends to make what kind of request, or whether the user asks for what kind of response usually, through conversation with the user. However, when there is a plurality of agents 10, the user needs to perform a process for growing the agents 10, for each of the agents 10.

Furthermore, for example, the agents 10 that are asked the question by the user access different services and obtain answers. Therefore, in some cases the plurality of agents 10 that is asked the same question by the user may generate different responses. In addition, some agents 10 may not be capable of accessing services for obtaining answers to the user's question and generating the answers. When no proper answer is obtained, the user needs to ask the same question to other agents 10 with effort.

Therefore, the response processing device 100 according to the present disclosure solves the problems described above by the response process described below.

Specifically, the response processing device 100 functions as a front-end device for the plurality of agents 10, and collectively accepts an interaction with the user. For example, the response processing device 100 analyzes the content of the question from the user and generates the command depending on the content of the question. Then, the response processing device 100 collectively transmits the generated command to the agent 10A, agent 10B, agent 10C, and agent 10D. Furthermore, the response processing device 100 presents the responses generated by the respective agents 10 to the user, and transmits to the agents 10 user's reaction to the presented responses.

This makes it possible for the response processing device 100 to solve the problem of a user environment in which the results from the plurality of agents 10 cannot be received unless the same command is executed many times. In addition, the response processing device 100 solves the problem of a situation where the process for growing the agents 10 needs be performed for each of the agents 10. In this way, the response processing device 100 behaves as the front-end device for the plurality of agents 10, and controls the generation and output of the response to improve the convenience of the user. The response processing device 100 plays, so to speak, a role of mediation for the entire system.

Hereinafter, an example of the response process of the first embodiment according to the present disclosure will be described following the process with reference to FIG. 1.

In the example illustrated in FIG. 1, it is assumed that the response processing device 100 is in cooperation with the agent 10A, agent 10B, agent 10C, and agent 10D in advance. For example, the response processing device 100 stores information such as a wake word for activating each agent 10 and a format for each agent 10 to receive voice (e.g., the type of a voice application programming interface (API) that can be processed by each agent 10, etc.), in a database.

The response processing device 100 receives some kind of input information from the user first (Step S1). For example, the response processing device 100 that is asked a spoken question by the user.

In this case, the response processing device 100 starts the response process of the response processing device 100 (Step S2). Furthermore, the response processing device 100 activates the agents 10 that are in cooperation with each other, upon reception of the input information from the user (Step S3).

Specifically, the response processing device 100 converts voice information received from the user into the command and generates the command having a format recognizable by each agent 10. Specifically, the response processing device 100 acquires user's voice, and analyzes the user's question contained in the user's voice through the processing of automatic speech recognition (ASR) or natural language understanding (NLU). For example, when the voice includes the intent of the question from the user, the response processing device 100 recognizes the intent of the question as the input information and generates a command according to the intent of the question. Note that the response processing device 100 may generate the commands of different modes from the same input information, for example, according to the APIs of the agents 10. Then, the response processing device 100 transmits the generated command to each agent 10.

For example, the agent 10A receiving the command generates the response corresponding to the input information. Specifically, the agent 10A generates the answer to the user's question as the response. Then, the agent 10A transmits the generated response to the response processing device 100 (Step S4). Although not illustrated in FIG. 1, the agent 10B, agent 10C, and agent 10D also transmit responses generated by the agent 10B, agent 10C, and agent 10D to the response processing device 100, as in the agent 10A.

The response processing device 100 collects the responses from the agents 10 and presents to the user information indicating which agent 10 has generated what kind of response (Step S5). For example, the response processing device 100 converts information that includes overviews of the responses received from the agents 10 into voice and outputs the converted voice to the user. Thereby, the user can obtain a plurality of the responses only by asking the response processing device 100 the question.

Then, the user tells the response processing device 100 whether to actually output which of the responses generated by the agents 10. The response processing device 100 collectively transmits the content of the response selected by the user, identification information of an agent 10 selected by the user, and the like to the agents 10. This makes it possible for each agent 10 to obtain, as the feedback, the response selected by the user to the user's question, that is, a positive example for the user. Furthermore, each agent 10 can obtain, as the feedback, the other responses not selected by the user to the user's question, that is, negative examples for the user. Therefore, the response processing device 100 enables learning of the plurality of agents 10 (feedback to each agent 10) in one interaction.

### 1-2. Example of Response Process According to First Embodiment

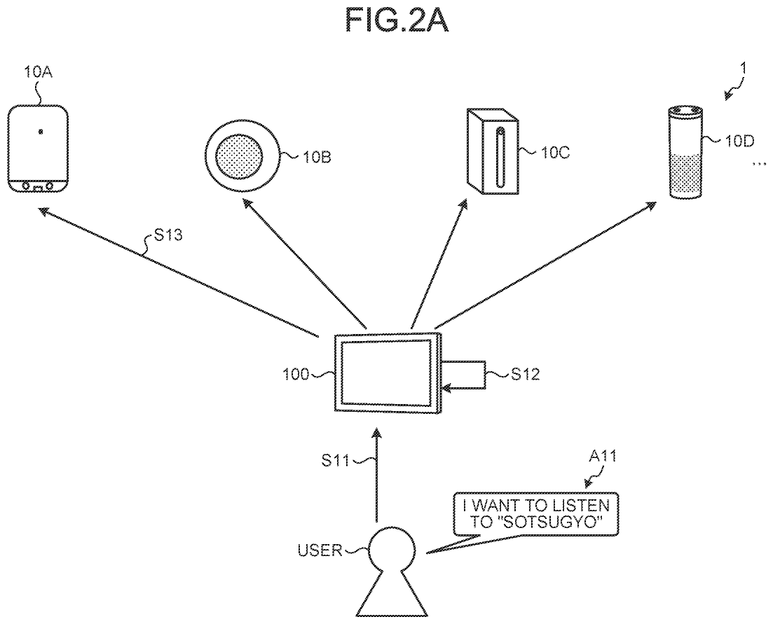

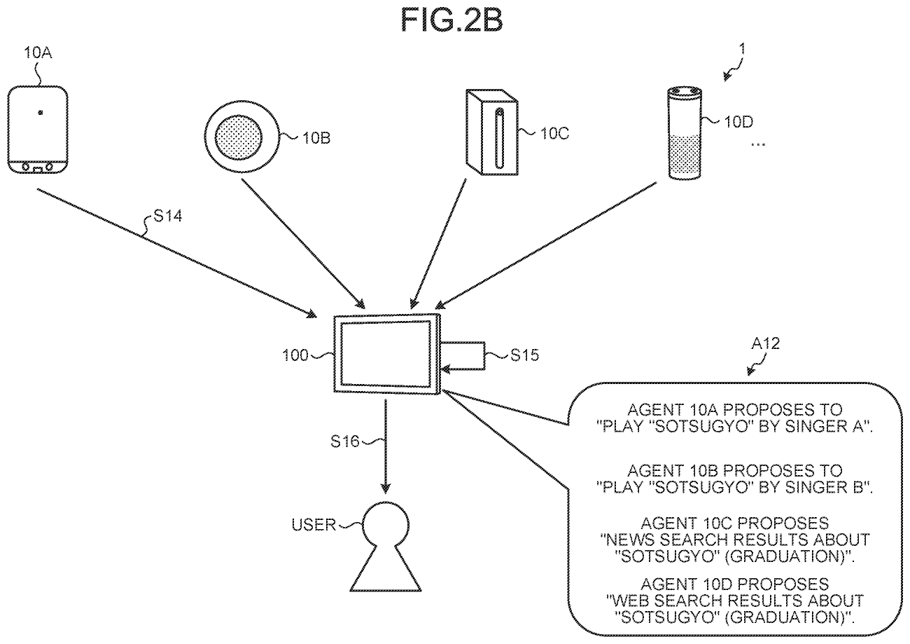

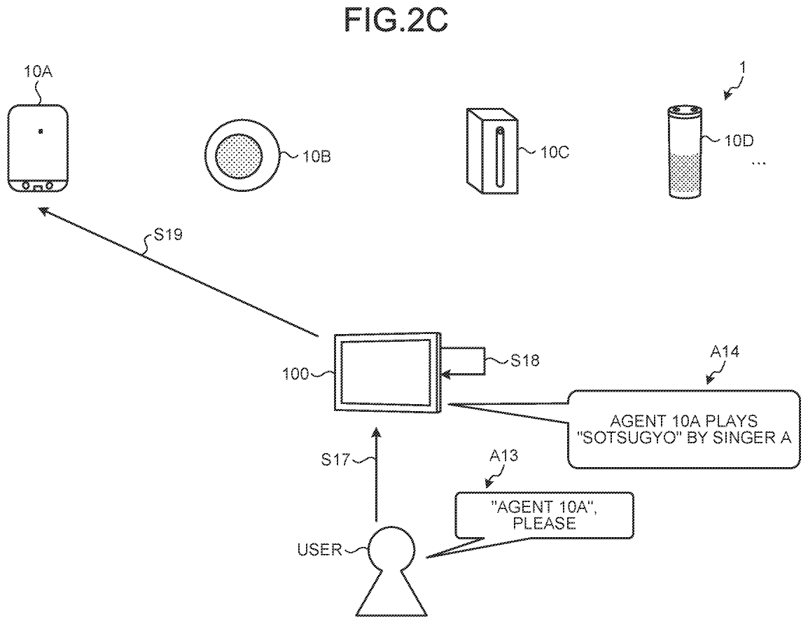

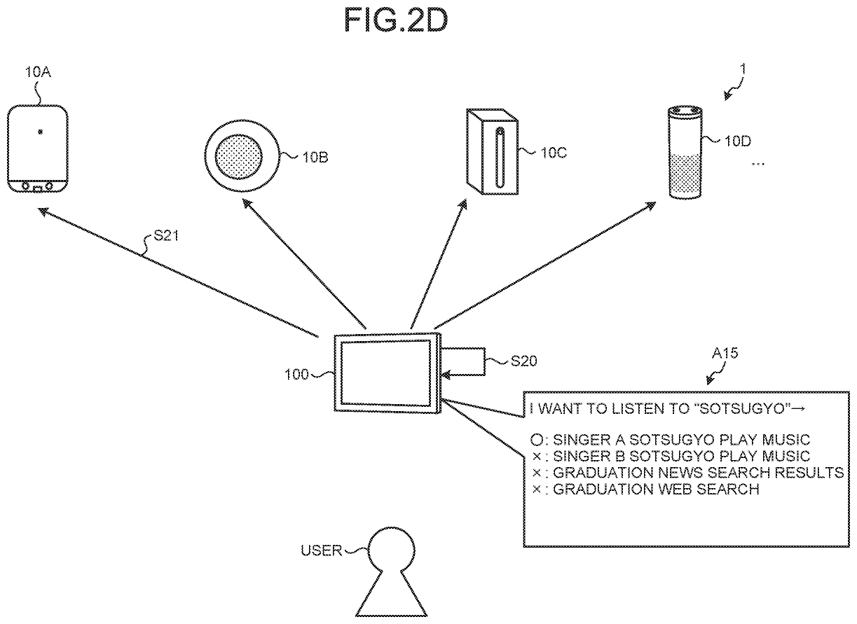

Next, an example of the response process described above will be described with reference to FIG. 2. FIG. 2A is a diagram (1) illustrating an example of the response process according to the first embodiment.

In the example of FIG. 2A, the user inputs voice A11 that includes the content that “I want to listen to “Sotsugyo” (graduation)”, to the response processing device 100 (Step S11). The response processing device 100 receives the voice A11 of the user, as the input information.

Subsequently, the response processing device 100 performs ASR or NLU processing on the voice A11 and analyzes the content thereof. Then, the response processing device 100 generates the command corresponding to the voice A11 (Step S12).

The response processing device 100 transmits the generated command to each agent 10 (Step S13). For example, the response processing device 100 refers to the API or a protocol with which each agent 10 is compatible and transmits the command having a format compatible with each agent 10.

The process continued from FIG. 2A will be described with reference to FIG. 2B. FIG. 2B is a diagram (2) illustrating an example of the response process according to the first embodiment.

Each agent 10 generates the response corresponding to the command on the basis of the command received from the response processing device 100. For example, it is assumed that the agent 10A interprets, on the basis of the content of the command, the user's request as “playing the song “Sotsugyo””. In this case, the agent 10A accesses, for example, a music service to which the agent 10A is allowed to be connected, and acquires the song “Sotsugyo” sung by a singer A. Then, the agent 10A transmits, to the response processing device 100, that “playing the song “Sotsugyo” sung by the singer A” is the response generated by the agent 10A (Step S14).

Likewise, it is assumed that the agent 10B interprets, on the basis of the content of the command, the user's request as “playing the song “Sotsugyo””. In this case, the agent 10B accesses, for example, a music service to which the agent 10B is allowed to be connected, and acquires the song “Sotsugyo” sung by a singer B. Then, the agent 10B transmits, to the response processing device 100, that “playing the song “Sotsugyo” sung by the singer B” is the response generated by the agent 10B.

In addition, it is assumed that the agent 10C interprets, on the basis of the content of the command, the user's request as “reproducing information about “Sotsugyo” (graduation)”. In this case, the agent 10B accesses, for example, a news service to which the device is allowed to be connected and acquires information about “Sotsugyo” (graduation) (news information in this example). Then, the agent 10C transmits, to the response processing device 100, that “reproducing the news about “Sotsugyo” (graduation)” is the response generated by the agent 10C.

In addition, it is assumed that the agent 10D interprets, on the basis of the content of the command, the user's request as “reproducing information about “Sotsugyo” (graduation)”. In this case, it is assumed that the agent 10B, for example, performs a web search to search for information about “Sotsugyo” (graduation). Then, the agent 10D transmits, to the response processing device 100, that “reproducing a result of the web search for “Sotsugyo” (graduation)” is the response generated by the agent 10D.

The response processing device 100 acquires the responses generated by the agents 10. Then, the response processing device 100 generates information indicating that what kind of response has been generated by each agent 10 (Step S15). For example, the response processing device 100 generates voice A12 that includes overviews of the responses generated by the agents 10.

Subsequently, the response processing device 100 outputs the generated voice A12 and presents the information contained in the voice A12 to the user (Step S16). Thereby, the user can know the contents of four types of responses only by inputting the voice A11 to the response processing device 100.

The process continued from FIG. 2B will be described with reference to FIG. 2C. FIG. 2C is a diagram (3) illustrating an example of the response process according to the first embodiment.

The user who listens to the voice A12 selects any of the responses included in the voice A12. In the example of FIG. 2C, it is assumed that the user determines that the response proposed by the agent 10A meets the request of the user. In this case, the user inputs voice A13 that includes the content such as ““Agent 10A”, please”, into the response processing device 100 (Step S17).

When receiving the voice A13, the response processing device 100 determines that the response of the agent A10, of the responses being held, is the response requested by the user (Step S18). In this case, the response processing device 100 generates and outputs voice A14 for guide, “Agent 10A plays “Sotsugyo” by singer A”. Furthermore, the response processing device 100 requests the agent 10A to output the generated response (Step S19). The agent 10A performs “playing “Sotsugyo” by singer A”, which is the response generated by the agent 10A, in response to the request.

Thereby, the user can output the response that is most suitable for the request of the user from among the presented responses.

The process continued from FIG. 2C will be described with reference to FIG. 2D. FIG. 2D is a diagram (4) illustrating an example of the response process according to the first embodiment.

After the agent 10A outputs the response, the response processing device 100 generates the feedback on a series of conversations with the user (Step S20).

For example, the response processing device 100 generates, as the feedback, the contents of the responses generated for the input information by the agents 10. Furthermore, the response processing device 100 generates, as the feedback, information indicating that, for example, of the responses generated by the agents 10, which response generated by which agent 10 is selected by the user and which response generated by which agent 10 is not selected by the user. As illustrated in FIG. 2D, the response processing device 100 generates feedback A15 that indicates the input information, the generated responses, and the response selected.

Then, the response processing device 100 transmits the generated feedback A15 to the agents 10 (Step S21). Thereby, the user can collectively provide the feedback to all the agents 10 without having the same conversation with all the agents 10, enabling efficient learning of the agents 10.

### 1-3. Variations of Response Process According to First Embodiment

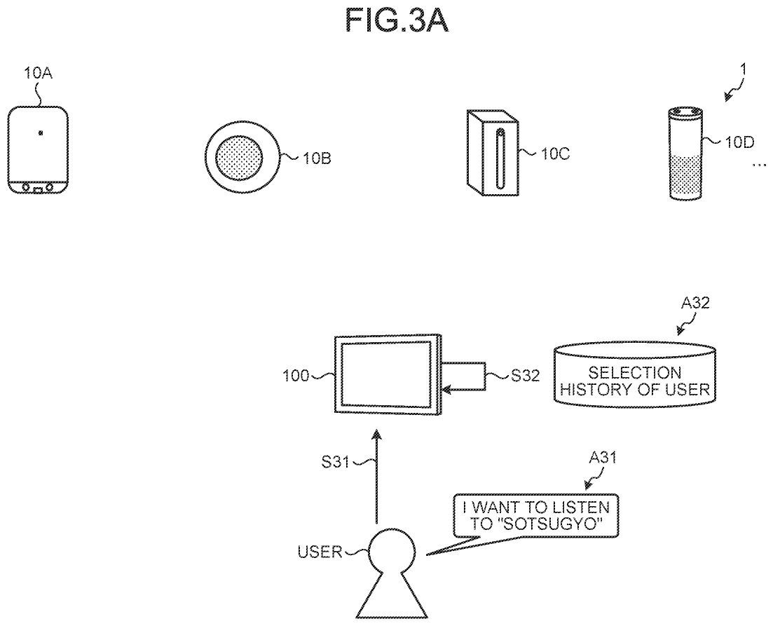

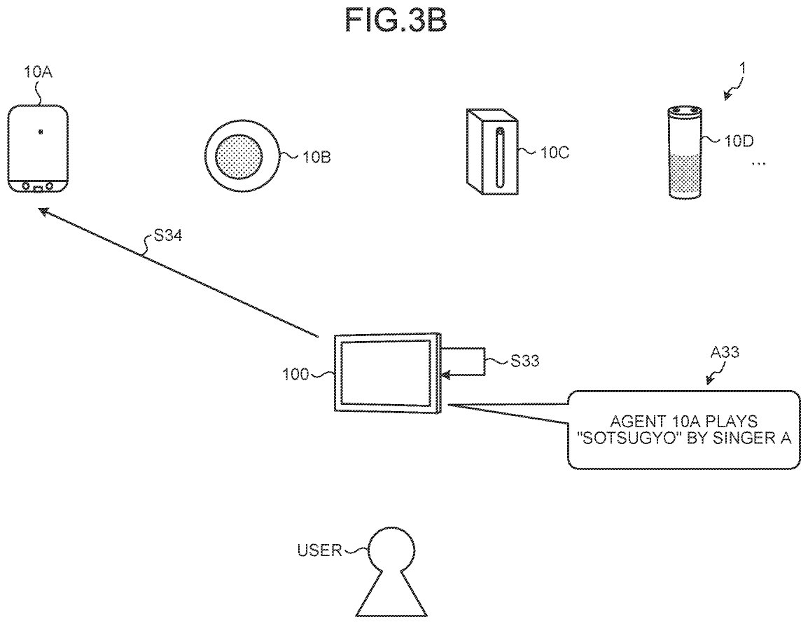

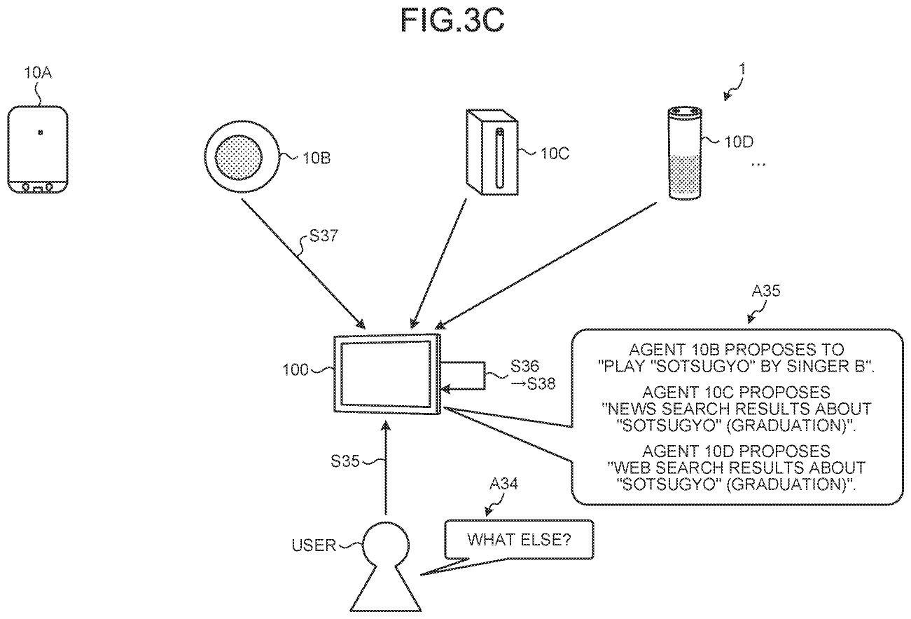

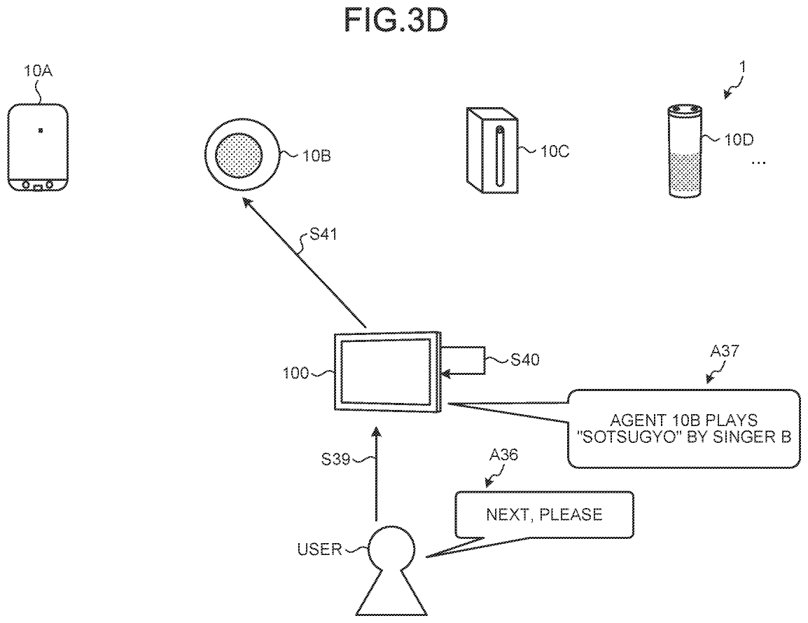

Next, variations of the response process described above will be described with reference to FIGS. 3 to 6. FIG. 3A is a diagram (1) illustrating a first variation of the response process according to the first embodiment.

In the example of FIG. 3A, the user inputs voice A31 that includes the content that “I want to listen to “Sotsugyo” (graduation)”, to the response processing device 100, as in FIG. 2A (Step S31). The response processing device 100 receives the voice A31 from the user, as the input information.

In the example of FIG. 3A, the response processing device 100 that has received the voice A31 refers to a selection history A32 of the user that indicates user's past selection of what kind of response or which agent 10 for the same or similar input information (Step S32). Specifically, the response processing device 100 refers to the type of response (playing the music, playing the news, etc.) selected by the user in the past, the number of times, frequency, ratio, or the like of selecting each agent 10.

The process continued from FIG. 3A will be described with reference to FIG. 3B. FIG. 3B is a diagram (2) illustrating the first variation of the response process according to the first embodiment.

The response processing device 100 that refers to the selection history A32 of the user in Step S32 determines whether the user has a tendency to select what kind of response or whether the user has a tendency to select which agent 10, when receiving the input information such as the voice A31. Then, after acquiring the responses generated by the agents 10, the response processing device 100 determines whether to output which response, that is, whether to output the response from which agent 10, on the basis of a past selection history of the user without presenting the plurality of responses to the user (Step S33).

In the example of FIG. 3B, it is assumed that the response processing device 100 determines that the user is likely to select the response generated by the agent 10A, on the basis of the past selection history of the user. In this case, the response processing device 100 outputs voice A33 indicating that the response generated by the agent 10A is output to the user, without presenting the responses generated by the agents 10.

Then, the response processing device 100 requests the agent 10A to output the generated response (Step S34). The agent 10A performs “playing “Sotsugyo” by singer A”, which is the response generated by the agent 10A, in response to the request.

In this way, the response processing device 100 may evaluate the responses generated by the agents 10 on the basis of the past selection history of the user to automatically select a response suitable for the user. Thereby, the user can cause the response that matches the tendency or preference of the user to output without presentation of the plurality of responses, thereby enjoying an efficient conversation process.

Note that the response processing device 100 may select a response to be output, according to the tendency of the user to prefer which agent 10, or may select a response to be output, according to the type of the response generated by each agent 10 and the tendency of the user to prefer which type of response.

The process continued from FIG. 3B will be described with reference to FIG. 3C. FIG. 3C is a diagram (3) illustrating the first variation of the response process according to the first embodiment.

The example of FIG. 3C shows a situation in which the user who looks at or listens to the response automatically selected by the response processing device 100 desires to know the contents of the other responses. At this time, the user inputs voice A34 such as “What else?” into the response processing device 100 (Step S35).

When receiving information, such as the voice A34, indicating an intent to select a response or agent 10, the response processing device 100 performs processing according to the intention of the user. Note that in the following, in some cases a request indicating a specific intent such as to select a response or agent 10, as in the voice A34, is referred to as a “specific command”. The specific commands may be registered in advance in the response processing device 100 or may be individually registered by the user.

The response processing device 100 performs processing according to the specific command included in the voice A34 (Step S36). For example, the specific command contained in the voice A34 is issued to “present a response generated by another agent 10”. In this case, the response processing device 100 presents a response generated by an agent 10 other than the agent 10A to the user.

For example, the response processing device 100 reads the other responses that are held after being acquired from the other agents 10 when receiving the voice A31. Alternatively, the response processing device 100 may transmit the command corresponding to the voice A31 to the agent 10B, the agent 10C, and the agent 10D again to acquire the responses generated by the agents 10B, 10C, and 10D (Step S37).

Then, the response processing device 100 generates voice A35 for presenting the responses generated by the agent 10B, the agent 10C, and the agent 10D (Step S38). The voice A35 contains voice indicating the contents of the responses generated by the agent 10B, the agent 10C, and the agent 10D. The response processing device 100 outputs the generated voice A35 to the user.

The process continued from FIG. 3C will be described with reference to FIG. 3D. FIG. 3D is a diagram (4) illustrating the first variation of the response process according to the first embodiment.

The example of FIG. 3D shows a situation in which the user who confirms the voice A35 desires to look at or listen to the content of another response. At this time, the user inputs, for example, voice A36 such as “Next, please”, into the response processing device 100 (Step S39).

It is assumed that the voice A36 is the specific command indicating “change in an output source, from an agent 10 being outputting the response to the next agent 10”. In this case, the response processing device 100 controls the change in the output source, from the agent 10A that is outputting “Sotsugyo” by singer A to the agent 10B, according to the intent of the specific command. Furthermore, the response processing device 100 outputs voice A37 indicating that the output source is to be changed to the agent 10B, to the user (Step S40).

Then, the response processing device 100 requests the agent 10A to stop the response being output and the agent 10B to output the response (Step S41).

In this way, even if a response that is not desired by the user is output, the user can output a response that the user desires by only performing a simple operation such as the specific command.

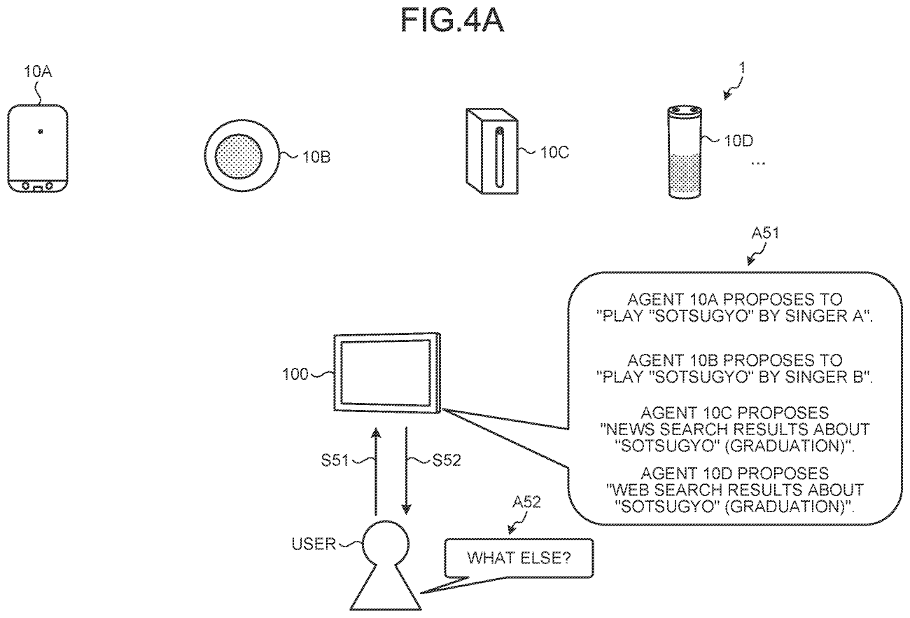

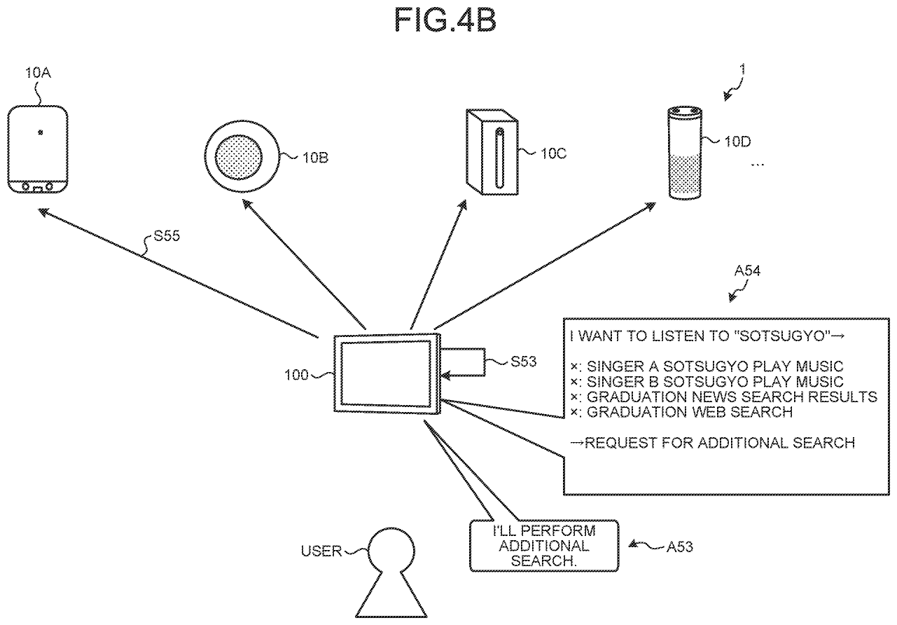

Next, a different variation of the response process will be described with reference to FIG. 4. FIG. 4A is a diagram (1) illustrating a second variation of the response process according to the first embodiment.

The example of FIG. 4A shows a situation in which a similar conversation as in FIGS. 2A and 2B is held between the response processing device 100 and the user, and voice A51 having a content similar to that of the voice A12 is presented by the response processing device 100 (Step S51).

At this time, it is assumed that the user determines that the content presented by the voice A51 does not include the content desired by the user. In this case, the user inputs voice A52 such as “What else?” into the response processing device 100 (Step S52).

The process continued from FIG. 4A will be described with reference to FIG. 4B. FIG. 4B is a diagram (2) illustrating the second variation of the response process according to the first embodiment.

The response processing device 100 receives the voice A52 and executes the specific command included in the voice A52. As described above, the specific command included in the voice A52 requests “output of the responses generated by the other agents 10”, but in FIG. 4A, the response processing device 100 presents the responses of all agents 10 that are in cooperation with each other.

In this case, the response processing device 100 determines that the presented responses have no response with which the user is satisfied. Then, the response processing device 100 causes each agent 10 to perform an additional search to generate a response to the user's request. At this time, the response processing device 100 outputs voice A53 indicating, to the user, that each agent 10 is caused to perform the additional search.

Furthermore, the response processing device 100 generates feedback A54 that indicates the contents of the responses generated to the input information and non-selection of all the responses (Step S53). Then, the response processing device 100 transmits a request for the additional search to the agents 10 together with the feedback A54 (Step S54).

In this way, the response processing device 100 transmits the request for the additional search to the agents 10, together with the feedback A54 indicating the contents of the responses generated by the agents 10 and non-selection of all the responses. This makes it possible for each agent 10 to perform the additional search after recognizing that the responses generated by the other agents 10 are inappropriate in addition to the response generated by the corresponding agent 10. Thereby, the user can efficiently obtain the response desired by the user, compared with the additional search that the individual agents 10 are caused to perform the additional search.

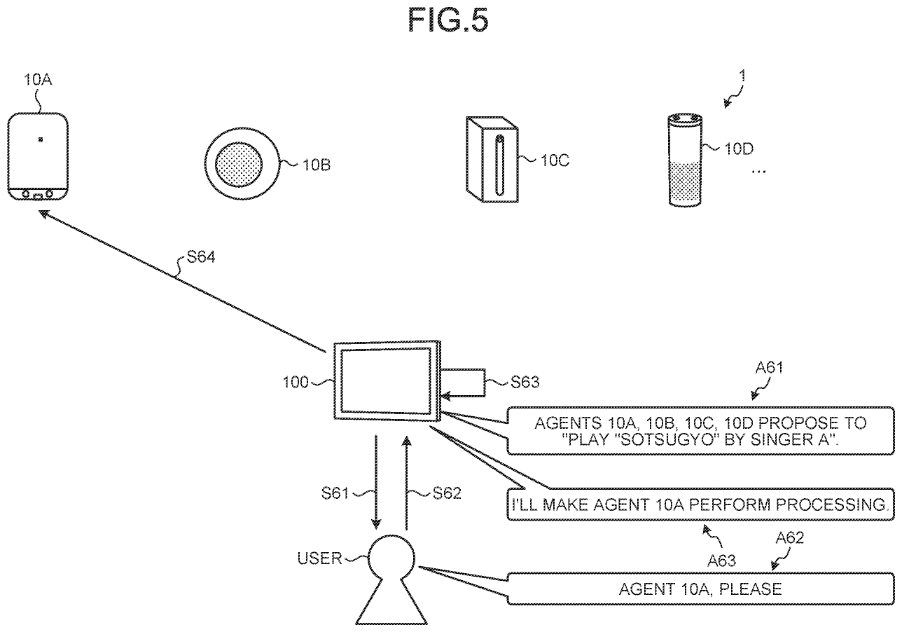

Next, a different variation of the response process will be described with reference to FIG. 5. FIG. 5 is a diagram illustrating a third variation of the response process according to the first embodiment.

The example of FIG. 5 shows a situation in which when the response processing device 100 receives the input information similar to the voice A11 illustrated in FIG. 2A and causes the agents 10 to generate the responses, all the agents 10 present the same response content.

In this case, the response processing device 100 presents, to the user, voice A61 indicating that all agents 10 have generated the same response (Step S61).

In this case, the user inputs, into the response processing device 100, that the response is to be output from a specific agent 10. For example, the user inputs voice A62 such as “Agent 10A, please” into the response processing device 100 (Step S62).

The response processing device 100 performs processing based on/on the basis of the specific command (“make the agent 10A output the response”) included in the voice A62 (Step S63). Specifically, the response processing device 100 generates and outputs voice A63 for guide, “I'll make the agent 10A perform the processing”. Furthermore, the response processing device 100 requests the agent 10A to output the generated response (Step S64).

As described above, when the responses obtained from the agents 10 have the same content, the response processing device 100 may generate an output such as the voice A61 indicating that the same response is generated. This makes it possible for the response processing device 100 to convey concise information to the user.

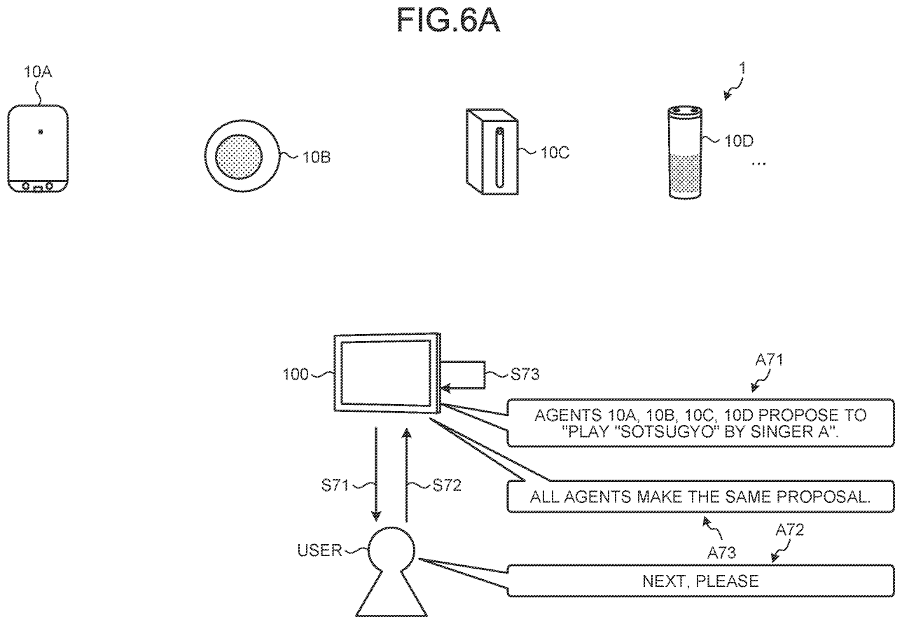

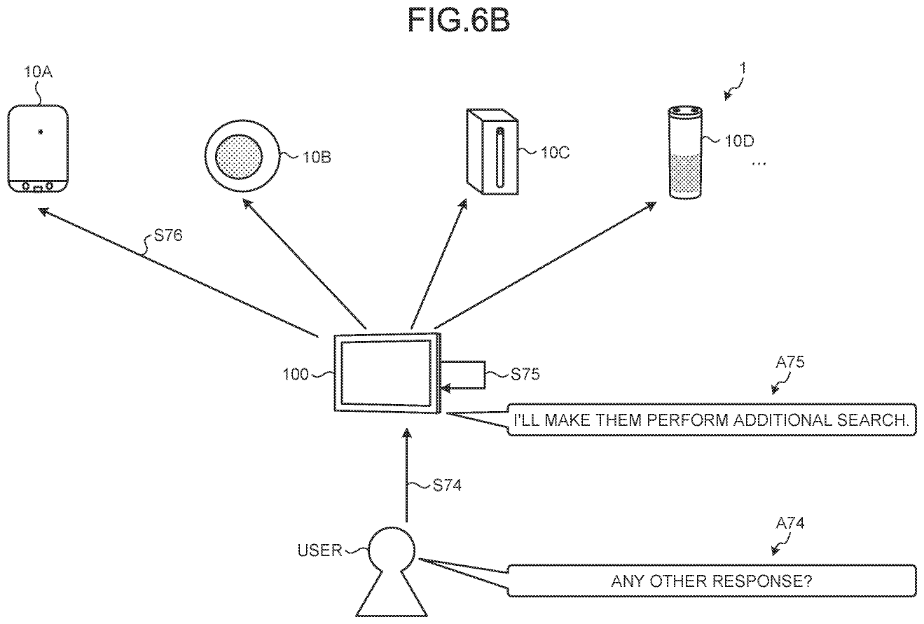

Next, a different variation of the response process will be described with reference to FIG. 6. FIG. 6A is a diagram (1) illustrating a fourth variation of the response process according to the first embodiment.

The example of FIG. 6 shows a situation in which, as in the example of FIG. 5, when the response processing device 100 causes the agents 10 to generate the responses on the basis of certain input information, all the agents 10 present the same response content.

In this case, the response processing device 100 presents, to the user, voice A71 indicating that all the agents 10 have generated the same response (Step S71).

At this time, it is assumed that the user determines that the content presented by the voice A71 does not include the content desired by the user. In this case, the user inputs voice A72 such as “Next, please”, into the response processing device 100 (Step S72).

The response processing device 100 receives the voice A72 and executes the specific command included in the voice A72. For example, the specific command included in the voice A72 requests “output of the response generated by the next agent 10 instead of the response generated by the agent 10 and is being output now”, but in FIG. 6A, the response processing device 100 already presents the responses of all agents 10 that are in cooperation with each other.

Therefore, the response processing device 100 generates voice A73 indicating that all agents 10 that are in cooperation with each other have generated the responses having the same content (Step S73). Then, the response processing device 100 outputs the generated voice A73 to the user.

The process continued from FIG. 6A will be described with reference to FIG. 6B. FIG. 6B is a diagram (2) illustrating the fourth variation of the response process according to the first embodiment.

The example of FIG. 6B shows a situation in which the user who confirms the voice A73 desires to look at or listen to the content of another response. At this time, the user inputs voice A74 such as “Any other response?” into the response processing device 100 (Step S74).

The response processing device 100 receives the voice A74 and executes the specific command included in the voice A74. As described above, the specific command included in the voice A74 requests “output of the responses generated by the other agents 10”, but in FIG. 6A, the response processing device 100 presents the responses of all agents 10 that are in cooperation with each other.

In this case, the response processing device 100 determines that the presented responses have no response with which the user is satisfied. Then, the response processing device 100 causes each agent 10 to perform an additional search to generate a response to the user's request. At this time, the response processing device 100 outputs voice A75 indicating, to the user, that each agent 10 is caused to perform the additional search (Step S75).

Then, as in the example illustrated in FIG. 4B, the response processing device 100 transmits the request for the additional search to the agents 10, together with the feedback indicating the contents of the responses generated for the input information and non-selection of all the responses (Step S76).

In this way, the response processing device 100 appropriately interprets the content of the specific command according to the content of the response generated by each agent 10 or the content already presented to the user, and performs the information processing according to situation. Thereby, the user can efficiently obtain the response desired by the user with only a concise conversation.

As described above, the response processing device 100 according to the first embodiment receives the input information, that is, information that triggers the generation of the response by each agent 10, from the user, as illustrated in FIGS. 1 to 6. Then, the response processing device 100 presents to the user the responses generated for the input information by the plurality of agents 10. Furthermore, the response processing device 100 transmits the user's reaction to the presented responses to the plurality of agents 10.

In this way, the response processing device 100 functions as the front end that mediates the conversation between the plurality of agents 10 and the user, and thus, the user can obtain information acquired by the plurality of agents 10 or the responses output by the plurality of agents 10 by conversation only with the response processing device 100. Furthermore, the response processing device 100 transmits, as the feedback, the user's reaction to the presented responses, to the agents 10, enabling efficient learning of the plurality of agents 10. This makes it possible for the response processing device 100 to improve the convenience of the user.

### 1-4. Configuration of Response Processing System According to First Embodiment

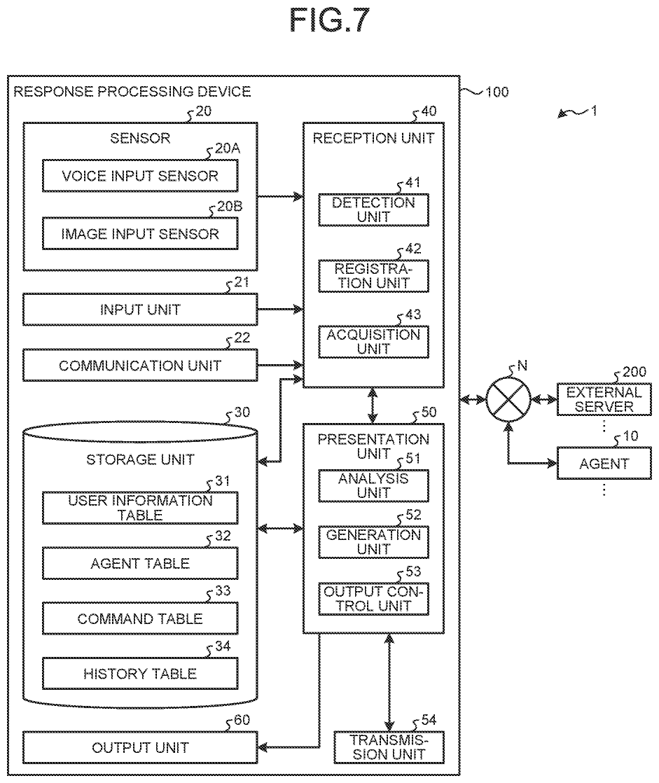

Next, the configuration of the response processing device 100 and the like according to the first embodiment described above will be described with reference to FIG. 7. FIG. 7 is a diagram illustrating a configuration example of the response processing system 1 according to the first embodiment of the present disclosure.

As illustrated in FIG. 7, the response processing system 1 includes an agent 10, the response processing device 100, and an external server 200. The agent 10, the response processing device 100, and the external server 200 are communicably connected via a network N (e.g., the Internet) illustrated in FIG. 7 in a wired or wireless manner. Note that although not illustrated in FIG. 7, the response processing system 1 may include a plurality of the agents 10 or a plurality of the external servers 200.

The agent 10 is an information processing terminal that is used by the user. The agent 10 has a conversation with the user and generates the response to the voice, action, or the like of the user. Note that the agent 10 may include whole or part of the configuration included in the response processing device 100, which is described later.

The external server 200 is a service server that provides various services. For example, the external server 200 provides a music service, weather information, traffic information, and the like according to requests from the agent 10 and response processing device 100.

The response processing device 100 is an information processing terminal that performs the response process according to the present disclosure. As illustrated in FIG. 7, the response processing device 100 has a sensor 20, an input unit 21, a communication unit 22, a storage unit 30, a reception unit 40, a presentation unit 50, a transmission unit 54, and an output unit 60.

The sensor 20 is a device configured to detect various kinds of information. The sensor 20 includes, for example, a voice input sensor 20A configured to collect user's speech voice. The voice input sensor 20A is, for example, a microphone. Furthermore, the sensor 20 includes, for example, an image input sensor 20B. The image input sensor 20B is, for example, a camera configured to capture an image of the user's movement or facial expression, the situation in a user's home, or the like.

Furthermore, the sensor 20 may include a touch sensor configured to detect the user's touching the response processing device 100, an acceleration sensor, a gyro sensor, or the like. Furthermore, the sensor 20 may include a sensor configured to detect the current position of the response processing device 100. For example, the sensor 20 may receive a radio wave transmitted from a global positioning system (GPS) satellite to detect position information (e.g., latitude and longitude) indicating the current position of the response processing device 100 on the basis of the received radio wave.

Furthermore, the sensor 20 may include a radio wave sensor configured to detect a radio wave emitted by the external device, an electromagnetic wave sensor configured to detect an electromagnetic wave, or the like. Furthermore, the sensor 20 may detect an environment in which the response processing device 100 is placed. Specifically, the sensor 20 may include an illuminance sensor configured to detect illuminance around the response processing device 100, a humidity sensor configured to detect humidity around the response processing device 100, a geomagnetic sensor configured to detect a magnetic field at the location of the response processing device 100, or the like.

Furthermore, the sensor 20 may not be necessarily included in the response processing device 100. For example, the sensor 20 may be installed outside the response processing device 100, as long as the sensor 20 is allowed to transmit information sensed to the response processing device 100 by communication or the like.

The input unit 21 is a device configured to receive various operations from the user. For example, the input unit 21 is achieved by a keyboard, mouse, touch panel, or the like.

The communication unit 22 is achieved by, for example, a network interface card (NIC) or the like. The communication unit 22 is connected to the network N in a wired or wireless manner to transmit/receive information to/from the agent 10, the external server 200, or the like via the network N.

The storage unit 30 is achieved by, for example, a semiconductor memory device such as a random access memory (RAM) or flash memory, or a storage device such as a hard disk or optical disk. The storage unit 30 has a user information table 31, an agent table 32, a command table 33, and a history table 34. Hereinafter, each data table will be described in order.

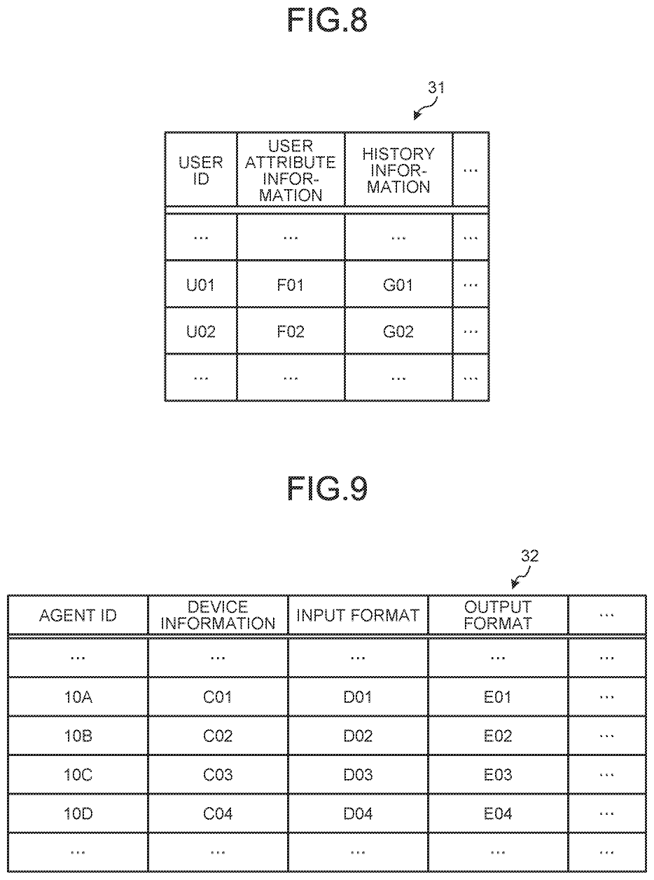

The user information table 31 stores information about the user who uses the response processing device 100 and the agent 10. FIG. 8 illustrates an example of the user information table 31 according to the first embodiment. FIG. 8 is a diagram illustrating an example of the user information table 31 according to the first embodiment of the present disclosure. In the example illustrated in FIG. 8, the user information table 31 has items such as “user ID”, “user attribute information”, and “history information”.

The “user ID” represents identification information that identifies each user. The “user attribute information” represents various information of each user registered by the user upon use of the response processing device 100. The example illustrated in FIG. 8 conceptually illustrates the item of the user attribute information, such as “F01”, but the user attribute information actually includes attribute information (user profile) such as the user's age, gender, place of residence, family structure, and the like. Furthermore, the user attribute information may include information required for selecting the type of information to be output, for example, a user has impaired vision. For example, when the impaired vision is registered in the user attribute information, the response processing device 100 may convert the content of the response that is usually displayed on the screen, into voice and output the voice. For such conversion, for example, a known technology such as text-to-speech (TTS) processing may be used.

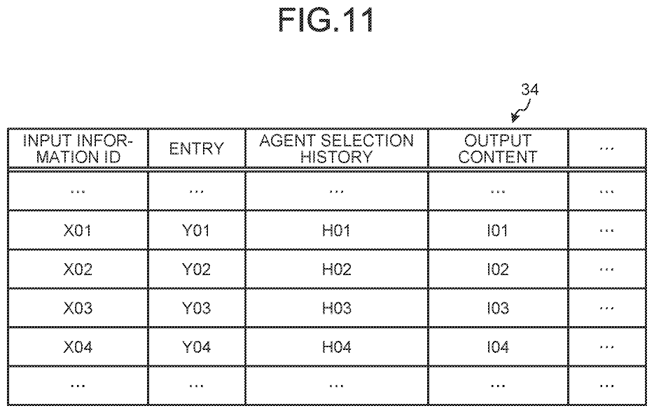

The “history information” represents a use history of the response processing device 100 by each user. The example illustrated in FIG. 8 conceptually illustrates the item of the history information, such as “G01”, but the history information actually includes various information such as the contents of the user's questions to the response processing device 100, a history of inquiries, a history of output responses, and the like. In addition, the history information may include voiceprint information, waveform information, or the like for identifying each user by voice. Furthermore, the “history information” illustrated in FIG. 8 may include information indicating the actions of each user in the past. Note that the history information will be described later in detail with reference to FIG. 11.

In other words, the example illustrated in FIG. 8 shows that the user identified by the user ID “U01” has user attribute information “F01” and history information “G01”.

Next, the agent table 32 will be described. The agent table 32 stores information about the agent 10 in cooperation with the response processing device 100.

FIG. 9 illustrates an example of the agent table 32 according to the first embodiment. FIG. 9 is a diagram illustrating an example of the agent table 32 according to the first embodiment of the present disclosure. In the example illustrated in FIG. 9, the agent table 32 has items such as “agent ID”, “device information”, “input format”, and “output format”.

The “agent ID” represents identification information that identifies the agent 10. Note that, in description, it is assumed that the agent ID and the reference numerals and symbols of the agent 10 are used in common. For example, the agent 10 identified by the agent ID “10A” means the “agent 10A”.

The “device information” represents information of the agent 10 as the information device. FIG. 9 conceptually illustrates the item of information device is conceptually described, such as “C01”, but the item of information device actually stores the type of the agent 10 as the information device (smart speaker, smartphone, robot, etc.), the type of function that the agent 10 can execute, and the like.

The “input format” represents information indicating that information input to the agent 10 has what kind of format. In the example illustrated in FIG. 9, the item of the input format is conceptually described, such as “D01”, but the item of the input format actually stores the type of voice format (“mp3”, “wav”, etc.) of data (voice, image, etc.) that can be processed by the agent 10, the file format of the command recognizable by the agent 10, and the like.

The “output format” represents the format of data that can be output by the agent 10. In the example illustrated in FIG. 9, the item of the output format is conceptually described, such as “E01”, but in reality, the item of the output format actually stores a specific form that the agent 10 can output, for example, whether the agent 10 is configured to output voice, to output an image, or output a moving image.

In other words, the example illustrated in FIG. 9 shows that the agent 10A identified by the agent ID “10A” has the device information “C01”, the input format “D01”, and the output format “E01”.

Next, the command table 33 will be described. The command table 33 stores information about the specific commands recognized by the response processing device 100.

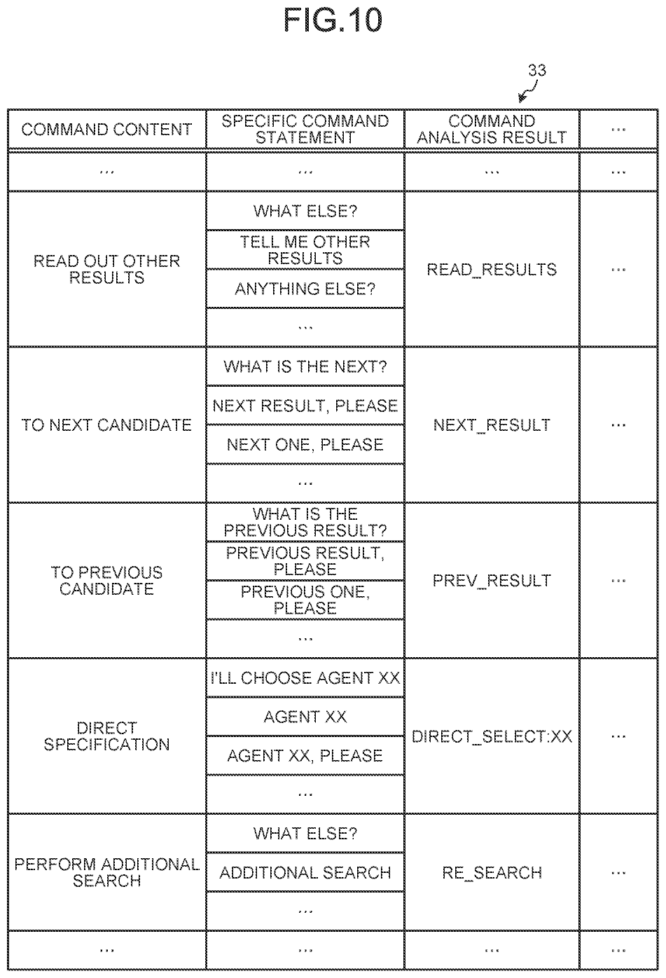

FIG. 10 illustrates an example of the command table 33 according to the first embodiment. FIG. 10 is a diagram illustrating the example of the command table 33 according to the first embodiment of the present disclosure. In the example illustrated in FIG. 10, the command table 33 has items such as “command content”, “specific command statement”, and “command analysis result”.

The “command content” represents the contents of processing performed by the response processing device 100 when each specific command is input. The “specific command statement” represents a statement (voice or text) corresponding to each specific command. The “command analysis result” represents a result of analysis of each specific command.

In other words, the example illustrated in FIG. 10 shows that a statement corresponding to the content of a command “read out other results” is voice or text such as “What else?”, “Tell me other results”, or “Anything else?”, and these statements are analyzed as a command (content of processing) such as “READ RESULTS”.

Note that the voices or texts corresponding to each specific command statement are not limited to those in the example illustrated in FIG. 10 and may be updated as appropriate on the basis of registration by the user him-/her-self.

Next, the history table 34 will be described. The history table 34 stores the history information about interaction between the response processing device 100 and each user.

FIG. 11 is a diagram illustrating an example of the history table 34 according to the first embodiment of the present disclosure. In the example illustrated in FIG. 11, the history table 34 has items such as “input information ID”, “entry”, “agent selection history”, and “output content”.

The “input information ID” represents identification information that identifies the input information. The “entry” represents the specific content of the input information. In FIG. 11, the item of entry is conceptually described, such as “Y01”, but the item of entry actually stores a result of analyzing voice (questions, etc.) of a user, a command generated according to the result of the analysis, and the like.

The “agent selection history” represents the identification information of the agent 10 selected for certain input information by the user, the number of times, ratio, frequency, or the like of selecting each agent 10. The “output content” represents an actual content output from the agent 10 or the response processing device 100 for certain input information, the type of information (music, search result, or the like) output, the number times, frequency, and the like of actually outputting various contents.

In other words, the example illustrated in FIG. 11 shows that the content of the input information identified by the input information ID “X01” is “Y01”, and the history of the agent 10 selected by the user for the input information is “H01”, and the history of the output content is “I01”.

Referring back to FIG. 7, the description will be continued. The reception unit 40, the presentation unit 50, and the transmission unit 54 each serve as a processing unit configured to execute information processing performed by the response processing device 100. The reception unit 40, the presentation unit 50, and the transmission unit 54 are achieved by executing programs (e.g., a response processing program according to the present disclosure) stored in the response processing device 100 by, for example, a central processing unit (CPU), a micro processing unit (MPU), or a graphics processing unit (GPU), with a random access memory (RAM) or the like as a working area. Furthermore, the reception unit 40, the presentation unit 50, and the transmission unit 54 each serve as a controller, and may be achieved by an integrated circuit such as an application specific integrated circuit (ASIC) or a field programmable gate array (FPGA).

The reception unit 40 is the processing unit configured to receive various information. As illustrated in FIG. 7, the reception unit 40 includes a detection unit 41, a registration unit 42, and an acquisition unit 43.

The detection unit 41 detects various information via the sensor 20. For example, the detection unit 41 detects user's speech voice via the voice input sensor 20A, which is an example of the sensor 20. In addition, the detection unit 41 may detect various information about the user's movement, such as the user's face information, the orientation, inclination, movement, or movement speed of the user's body, via the image input sensor 20B, an acceleration sensor, an infrared sensor, or the like. In other words, the detection unit 41 may detect, as the context, various physical quantities such as position information, acceleration, temperature, gravity, rotation (angular velocity), illuminance, geomagnetism, pressure, proximity, humidity, and rotation vector, via the sensor 20.

The registration unit 42 accepts registration from the user, via the input unit 21. For example, the registration unit 42 receives registration relating to the specific command from the user, via a touch panel or keyboard.

In addition, the registration unit 42 may accept registration of a schedule of the user or the like. For example, the registration unit 42 receives registration of the schedule by the user with an application function incorporated in the response processing device 100.

The acquisition unit 43 acquires various information. For example, the acquisition unit 43 acquires the device information of each agent 10, information about a response generated by each agent 10, and the like.

Furthermore, the acquisition unit 43 may receive a context related to communication. For example, the acquisition unit 43 may receive, as the context, a connection state between the response processing device 100 and each agent 10 or various devices (servers on a network, home appliances, etc.). The connection state with various devices represents, for example, information indicating whether mutual communication is established, a communication standard used for communication, or the like.

The reception unit 40 controls each of the processing units described above to receive various information. For example, the reception unit 40 acquires the input information being information that triggers generation of the response by each agent 10 from the user.

For example, the reception unit 40 acquires the voice information from the user, as the input information.

Specifically, the reception unit 40 acquires a user's speech such as “I want to listen to “Sotsugyo””, and acquires some kind of intent included in the speech as the input information.

Alternatively, the reception unit 40 may acquire detection information that is obtained by detecting the user's action, as the input information. The detection information is information that is detected by the detection unit 41 via the sensor 20. Specifically, the detection information is the user's action that triggers the generation of the response by the response processing device 100, such as information indicating that the user looks at the camera of the response processing device 100, information indicating that the user moves from a room to the front door in his/her home, or the like.

In addition, the reception unit 40 may receive the text input by the user, as the input information. Specifically, the reception unit 40 acquires the text input from the user, such as “I want to listen to “Sotsugyo””, via the input unit 21 and acquires some kind of intent contained in the text as the input information.

Furthermore, after the response generated by each agent 10 is presented by the presentation unit 50 which is described later and any of the presented responses is output, the reception unit 40 accepts the specific command indicating change of the response to be output, from the user. For example, the reception unit 40 receives the user's speech such as “What is the next?” as the specific command. In this case, the presentation unit 50 performs the information processing corresponding to the specific command (e.g., control another agent 10 registered following the agent 10 that is now outputting the response to output the response).

Furthermore, after the response generated by each agent 10 is presented by the presentation unit 50 which is described later, the reception unit 40 may receive the specific command indicating request for a response different from the presented response, from the user. For example, the reception unit 40 receives the user's speech such as “What else?” as the specific command. In this case, the presentation unit 50 performs the information processing corresponding to the specific command (e.g., control each agent 10 to perform the additional search).

In addition, the reception unit 40 may acquire information about various contexts. The context is information indicating various situations when the response processing device 100 generates the response. Note that the context includes “information indicating the user's situation” such as action information indicating that the user looks at the response processing device 100, and therefore, the context can also serve as input information.

For example, the reception unit 40 may acquire the user attribute information registered by the user in advance as the context. Specifically, the reception unit 40 acquires information such as the gender, age, or place of residence of the user. In addition, the reception unit 40 may acquire information indicating the characteristics of the user, for example, the user has impaired vision, as the attribute information. Furthermore, the reception unit 40 may acquire information such as the user's taste, as the context, on the basis of the use history of the response processing device 100 or the like.

Furthermore, the reception unit 40 may acquire position information indicating the user's position, as the context. The position information may be information indicating a specific position such as longitude and latitude, or information indicating which room the user is in, at home. For example, the position information may be information indicating the location of the user, for example, whether the user is in a living room, bedroom, or children's room at home. Alternatively, the position information may be information about a specific place to which the user goes out. In addition, the information about a specific place to which the user has gone out may include information indicating the situation, for example, the user is on a train, driving a car, or going to a school or work. The reception unit 40 may, for example, communicate with a mobile terminal such as a smartphone of the user to acquire such information.

In addition, the reception unit 40 may acquire prediction information in which the user's action or emotion is predicted, as the context. For example, the reception unit 40 acquires action prediction information that is information estimated from the user's action and indicating the user's action in the future, as the context. Specifically, the reception unit 40 acquires the action prediction information, for example, “the user is about to go out”, as information predicted on the basis of the user's action indicating that the user moves from the room to the front door in his/her home. For example, when acquiring the action prediction information, for example, “the user is about to go out”, the reception unit 40 acquires a tagged context such as “going out”, on the basis of the information.

Furthermore, the reception unit 40 may acquire schedule information that is registered in advance by the user, as the user's action. Specifically, the reception unit 40 acquires information about a schedule registered at the scheduled time within a predetermined period (e.g., within one day) from the time of the user's speech. This makes it possible for the reception unit 40 to predict information or the like, such as where the user is about to go out at the certain time.

Furthermore, the reception unit 40 may detect the speed of movement of the user, the location of the user, the speed of the user's speech, or the like captured by the sensor 20 to predict the situation or emotion of the user. For example, when the user speaks at a speed faster than that of normal speech of the user, the reception unit 40 may predict the situation or emotion that “the user is in a hurry”. For example, when the context indicating that the user is in a hurry than usual is acquired, the response processing device 100 can make adjustments, for example, for outputting a shorter response.

Note that the context described above is an example, and every information indicating the situation of the user or the response processing device 100 can be the context. For example, the reception unit 40 may acquire, as the context, various physical quantities such as the position information, acceleration, temperature, gravity, rotation (angular velocity), illuminance, geomagnetism, pressure, proximity, humidity, and rotation vector of the response processing device 100 obtained via the sensor 20. Furthermore, the reception unit 40 may acquire, as the context, the connection state with various devices (e.g., information about establishment of communication, and a communication standard being used) or the like, by using a communication function that is included in the reception unit 40.

Furthermore, the context may include information about conversation between the user and another user or between the user and the response processing device 100. For example, the context may include conversation context information indicating the context of the conversation of the user, domain of the conversation (weather, news, train status information, etc.), the intent of the user's speech, attribute information, or the like.

Furthermore, the context may include date-and-time information about the conversation. Specifically, the date-and-time information is information about date, time, a day of the week, the characteristics of holidays (Christmas, etc.), a period of time (morning, noon, night, midnight), or the like.

Furthermore, the reception unit 40 may acquire, as the context, various information indicating the situation of the user, such as information about a specific housework of the user, information about the content of a TV program the user watches, information about what the user eats, or information about conversation with a specific person.

In addition, the reception unit 40 may acquire information, for example, whether which appliance is activated (e.g., whether the power is on or off), or whether which appliance is performing what kind of processing, by communication with the appliances (IoT device etc.) in the home.

Furthermore, the reception unit 40 may acquire, as the context, a traffic situation, weather information, or the like in a living area of the user, by communication with the external service. The reception unit 40 stores each piece of acquired information in the user information table 31 or the like. Furthermore, the reception unit 40 may refer to the user information table 31 or agent table 32 to appropriately acquire information required for processing.

Next, the presentation unit 50 will be described. As illustrated in FIG. 7, the presentation unit 50 includes an analysis unit 51, a generation unit 52, and an output control unit 53.

For example, the analysis unit 51 analyzes the input information to enable each of a plurality of agents 10 selected to recognize the input information. The generation unit 52 generates the command corresponding to the input information, on the basis of the content analyzed by the analysis unit 51. In addition, the generation unit 52 transmits the generated command to the transmission unit 54 and causes the transmission unit 54 to transmit the generated command to each agent 10. The output control unit 53 is configured to, for example, output the content of the response generated by the agent 10, and control the agent 10 to output the response.

In other words, the presentation unit 50 presents the responses generated by the plurality of agents 10, for the input information received by the reception unit 40, on the basis of information obtained by the processing performed by the analysis unit 51, the generation unit 52, and the output control unit 53.

For example, the presentation unit 50 performs presentation for the user by using voice containing the content of each of the responses generated for the input information by the plurality of agents 10.

Furthermore, the presentation unit 50 controls an agent 10 generating a response selected by the user of the responses presented to the user, to output the selected response. For example, when the specific command specifying an output destination, for example, “Agent 10A, please”, is issued from the user, the presentation unit 50 transmits a request for the agent 10A to output the response actually generated. This makes it possible for the presentation unit 50 to control the agent 10A to output the response desired by the user.

Note that the presentation unit 50 may acquire the response selected by the user of the presented responses, from the agent 10 having generated the selected response, and output the acquired response by the response processing device 100. In other words, the presentation unit 50 may acquire data of the response (e.g., music data of “Sotsugyo”) to output the data by using the output unit 60 of the response processing device 100, instead of causing the agent 10A to output the response (e.g., playing the music “Sotsugyo”) generated by the agent 10A. This makes it possible for the presentation unit 50 to output the response desired by the user instead of the agent 10A that is, for example, installed at a position relatively distant from the user, improving the convenience of the user.

In addition, the presentation unit 50 performs processing corresponding to the specific command received by the reception unit 40. For example, when any of the responses presented is output and then the specific command indicating change of the response to be output is accepted from the user, the presentation unit 50 changes the response being output to a different response, on the basis of the specific command.

Note that when the responses generated by the plurality of agents 10 to the input information include the same content, the presentation unit 50 may collectively present the responses including the same content. This makes it possible for the presentation unit 50 to avoid a situation in which the responses having the same content are output to the user many times when the specific command such as “Next, please” is received from the user.

Furthermore, when receiving the specific command requesting a different response to the presented response from the user, the presentation unit 50 may transmit the request for the additional search with respect to the input information, to the plurality of agents 10 on the basis of the specific command.

Furthermore, the presentation unit 50 may refer to the history table 34 to select the response to be output, on the basis of the action of the user in the past. Specifically, the presentation unit 50 outputs, to the user, one response selected from the responses generated for the input information by the plurality of agents 10, on the basis of a history indicating responses generated by the plurality of agents 10, selected by the user in the past.

For example, when the response is output to the user who asks a question about certain information, the response processing device 100 might have a reaction such as “Tell me other information”, from the user. In this case, the response processing device 100 determines that information having been output is not information that the user desires. Meanwhile, when information output next is accepted by the user, the response processing device 100 determines that the information is the information that the user desires.

In this case, when the response processing device 100 is asked a similar question by the user next, the response processing device 100 may preferentially select an agent 10 capable of generating the response desired by the user. Furthermore, for example, when the user tends to desire an output from a certain agent 10 (when specification of a specific agent 10 as the output destination by the user is statistically frequent, etc.), the response processing device 100 may control the response to be preferentially output from the agent 10. In this way, the response processing device 100 performs learning on the basis of a history of the user's instructions or operations, and thus, the response processing that further meets the user's request can be performed. Furthermore, the user can thereby cause the response processing device 100 to output the response desired by the user without giving an instruction.

Furthermore, the presentation unit 50 may determine whether each of the plurality of agents 10 can generate the response to the input information to select an agent 10 that is not an agent 10 determined not to generate the response to the input information, as an agent 10 that generates the response corresponding to the input information. In other words, the presentation unit 50 may refer to the agent table 32 to select an agent 10 that is expected to be able to generate the response. This makes it possible for the presentation unit 50 to reduce the effort to randomly transmit the request to all the agents 10.

Note that the analysis unit 51 described above performs processing for understanding of the meaning of the information acquired by the reception unit 40. Specifically, the analysis unit 51 performs the processing of automatic voice recognition (ASR) or natural language understanding (NLU) on the voice information and the like by the reception unit 40. For example, the analysis unit 51 divides the acquired voice into morphemes through the ASR or NLU, and determines whether each morpheme is an element that has what kind of intent or attribute.

When the intention of the user cannot be understood as a result of analysis of the input information, the analysis unit 51 may transmit that the intention of the user cannot be understood to the output control unit 53. For example, when the user's speech contains information that cannot be understood, as the result of the analysis, the analysis unit 51 transmits the content of the information to the output control unit 53. In this case, the output control unit 53 may generate the response that requests the user to speak accurately again for the information that cannot be understood.

The transmission unit 54 transmits various information. For example, the transmission unit 54 transmits the user's reaction (feedback) to the response presented by the presentation unit 50, to the plurality of agents 10.

Specifically, the transmission unit 54 transmits, as the user's reaction, information about a response selected by the user from the presented responses, to the plurality of agents 10.

For example, the transmission unit 54 transmits, as the information about the response selected by the user, the content of the response selected by the user, the identification information of the agent 10 that has generated the response selected by the user, or the like, to the plurality of agents 10.

Furthermore, the transmission unit 54 may transmit, as the user's reaction, information indicating that none of the presented responses has been selected by the user, to the plurality of agents 10.

Furthermore, the transmission unit 54 may transmit the contents of the responses to the plurality of agents 10 together with information indicating that none of the presented responses has been selected by the user. This makes it possible for the transmission unit 54 to transmit the content of the response selected by the user or the content of the response not selected by the user, to the respective agents 10, enabling efficient learning of the agents 10.

Note that the transmission unit 54 transmits, to the agent 10, not only the user's reaction but also various information, such as a command and the request for outputting the response that are generated by the presentation unit 50. For example, when receiving the specific command from the user, the transmission unit 54 may transmit the request corresponding to the specific command (e.g., the request for the additional search with respect to the input information, based on the specific command, etc.), to the agent 10.

The output unit 60 is a mechanism for outputting various information. For example, the output unit 60 is a speaker or a display. For example, when the response is output by the output control unit 53, the output unit 60 outputs the name or the like of an agent 10 being the output destination, to the user by voice. Furthermore, the output unit 60 may output image data on the display. Furthermore, when the response processing device 100 generates the response by itself, the output unit 60 outputs the generated response by voice, as an image, or the like. Note that the output unit 60 may output the response in various forms, such as displaying characters obtained by character recognition of the generated voice data, on the display.

### 1-5. Procedure of Response Process According to First Embodiment

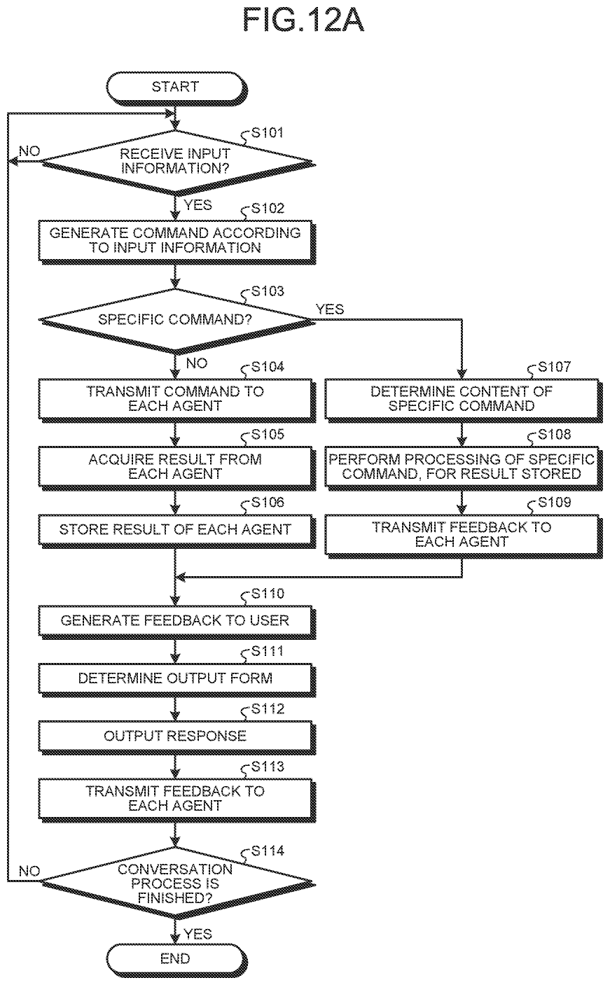

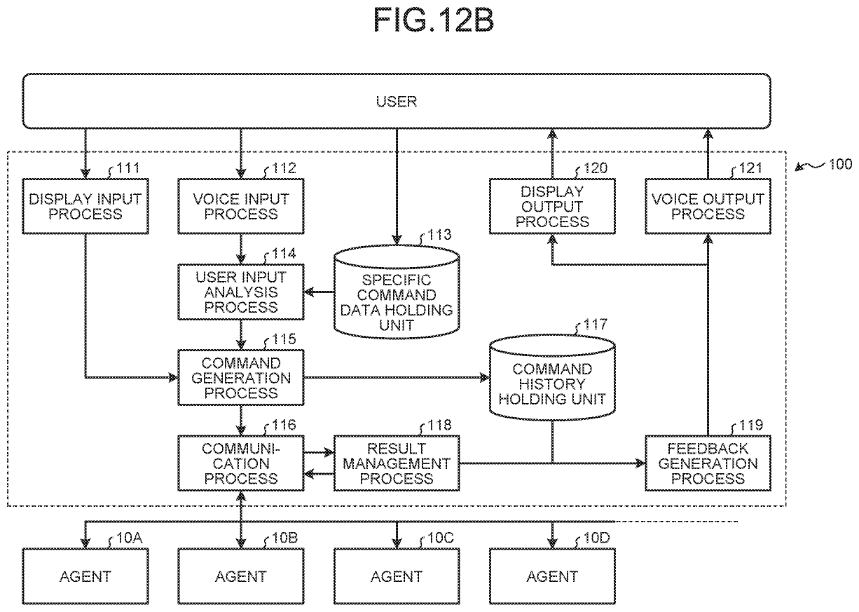

Next, a procedure of the response process according to the first embodiment will be described with reference to FIGS. 12A and 12B. FIG. 12A is a flowchart illustrating the process according to the first embodiment.

As illustrated in FIG. 12A, the response processing device 100 determines whether the input information is received (Step S101). If no input information is received (Step S101; No), the response processing device 100 waits for reception of the input information.

Meanwhile, if the input information is received (Step S101; Yes), the response processing device 100 analyzes the input information and generates the command according to the input information (Step S102). Specifically, the response processing device 100 analyzes the input information and generates the command indicating the user's intention, the content of the question, and the like included in the input information.

Subsequently, the response processing device 100 determines whether the generated command corresponds to the specific command (Step S103). If the generated command is not the specific command (Step S103; No), the response processing device 100 transmits the command generated in Step S102 to each agent 10 (Step S104).

Then, the response processing device 100 acquires a result of the response generated by each agent 10 according to the transmitted command (Step S105). At this time, the response processing device 100 temporarily stores the result generated by each agent 10 in the storage unit 30 (Step S106).

Note that if the generated command corresponds to the specific command in Step S103 (Step S103; Yes), the response processing device 100 determines the content of the specific command (Step S107).

Then, the response processing device 100 performs the processing of the specific command for the result stored in Step S106 or the like (Step S108). Furthermore, the response processing device 100 transmits the feedback to each agent 10 (Step S109).

After Step S106 or Step S109, the response processing device 100 generates the feedback to the user (Step S110). For example, the response processing device 100 generates the feedback for presenting each response generated by each agent 10 after Step S106. Alternatively, the response processing device 100 generates the feedback, such as voice, for transmitting that the response is to be output from which agent 10, after Step S109.

Subsequently, the response processing device 100, for example, receives a selection from the user or the like and determines an output form of the response (Step S111). Note that the output form of the response represents the content of an actual output, for example, whether to output which response or whether to output the response from which agent 10.

Then, the response processing device 100 outputs the response (Step S112). For example, the response processing device 100 controls the agent 10 that has generated the response to output the response, or outputs the response from the response processing device 100.

At this time, the response processing device 100 transmits the feedback to each agent 10 about the output content or the like (Step S113). Then, the response processing device 100 that has output the response to the user determines whether the conversation process with the user is finished (Step S114). Specifically, the response processing device 100 determines whether one session related to the conversation with the user is finished.

If the conversation process is not finished (Step S114; No), the response processing device 100 returns to Step S101 and continues the conversation process. On the other hand, if it is determined that the conversation process is finished (Step S114; Yes), the response processing device 100 finishes the process.

Next, the procedure of the response process according to the first embodiment will be described with reference to FIG. 12B illustrating a process block diagram. FIG. 12B is the block diagram illustrating the process according to the first embodiment.

A display input process 111 is configured to process a user's input via the display or the like of the response processing device 100. Specifically, in the display input process 111, the input information is transmitted to a command generation process 115 via a user interface or the like displayed on the touch panel display. The display input process 111 corresponds to, for example, the image input sensor 20B, the detection unit 41, and the like illustrated in FIG. 7.

A voice input process 112 is configured to perform a process of converting an input of the user's speech into character information (text). The voice input process 112 may include a signal processing function of reducing external ambient sound such as noise. The voice input process 112 transmits the input information to a user input analysis process 114. The voice input process 112 corresponds to, for example, the voice input sensor 20A illustrated in FIG. 7, the detection unit 41, and the like.

A specific command data holding unit 113 is a portion that holds the type of the specific command and a corresponding character string in association with each other. Note that the types of the specific command and the character string are configured to be edited by the user. The specific command data holding unit 113 corresponds to, for example, the command table 33 illustrated in FIG. 7.

In the user input analysis process 114, it is determined whether the input from the user is corresponds to the specific command, referring to the specific command data holding unit 113. As described above, the types of the specific commands include “receive the result from a specific agent 10” or “listen to the result from another agent 10”. In other words, in the user input analysis process 114, the user's voice and the like are analyzed to determine whether those voices correspond to the specific command. Note that, in the user input analysis process 114, when the received input does not correspond to the specific command, transmitting that there is no specific command (empty command analysis result) together with the input information (text, etc.), to the command generation process 115. The user input analysis process 114 corresponds to the processes performed by, for example, the presentation unit 50 and the analysis unit 51 illustrated in FIG. 7.

In the command generation process 115, the command to be transmitted to each agent 10 is generated, on the basis of the information input from the user or the command analysis result analyzed in the user input analysis process 114. Note that the command generated in the command generation process 115 is also transmitted to a command history holding unit 117 and is held as a history. The command generation process 115 corresponds to the processes performed by, for example, the presentation unit 50 and the generation unit 52 illustrated in FIG. 7.

A communication process 116 is configured to convert the command obtained through the command generation process 115 into a command having a format in conformity with a data format of each agent 10 connected to the response processing device 100, and transmit the information obtained after the conversion. Then, in the communication process 116, the result output from each agent 10 is obtained and the result is transmitted to a result management process 118. At this time, in the communication process 116, the acquired response is converted into a common format for result storage and held so as to show whether what kind of result is associated with which agent 10.

Furthermore, in the communication process 116, when the specific command is obtained, the specific command is transmitted to the result management process 118. Furthermore, in the communication process 116, information managed in the result management process 118 is acquired, and the content of the information is transmitted as the feedback to each agent 10. This feedback acts as a positive reward (positive example) or negative reward (negative example), for each agent 10. The communication process 116 corresponds to the processes performed by, for example, the presentation unit 50, the output control unit 53, and the transmission unit 54 illustrated in FIG. 7.

The command history holding unit 117 holds the commands issued in the command generation process 115 in time series. Note that the command history holding unit 117 may also calculate and hold the contents of the commands received, the frequency of issuance of the commands, or the like. The command history holding unit 117 corresponds to, for example, the user information table 31 and the history table 34.

In the result management process 118, the result obtained from each agent 10 is held and managed. In other words, information obtained through the conversation with the user is held for a certain period of time and is transmitted to a feedback generation process 119 or the communication process 116 according to the specific command received thereafter. Note that when a predetermined time has elapsed, the held result is appropriately discarded. The result management process 118 corresponds to the processes performed by, for example, the presentation unit 50, the generation unit 52, and the transmission unit 54 illustrated in FIG. 7.

In the feedback generation process 119, the content of the feedback to the user is generated on the basis of the information held in the result management process 118 and information about the frequency held in the command history holding unit 117. For example, in the feedback generation process 119, it may be determined that the result from an agent 10 frequently used is preferentially output, or the result may be randomly output each time. Furthermore, the user may edit such output settings as appropriate. Furthermore, when outputting voice or when the content held in the result management process 118 is long (news article result, etc.), the feedback generation process 119 may summarize the content. The feedback generation process 119 corresponds to the processes performed by, for example, the presentation unit 50 and the transmission unit 54 illustrated in FIG. 7.

A display output process 120 is configured to shape and display all of the results output from the agent 10, created in the feedback generation process 119, or a candidate selected therefrom on the display. The display output process 120 corresponds to the processes performed by, for example, the output control unit 53 and the output unit 60 illustrated in FIG. 7.

A voice output process 121 is configured to generate voice data from all of the results output from the agent 10, created in the feedback generation process 119, or the candidate selected therefrom, and play the voice data from a device such as the speaker. The voice output process 121 corresponds to the process performed by, for example, the output control unit 53 and the output unit 60 illustrated in FIG. 7.

Note that the processes described above are an example, and for example, different processes may be performed as appropriate depending on the configuration of the response processing device 100. For example, the input and output processes differ depending on application or service, and thus, the response processing device 100 does not necessarily require performance of both of output on the display and output of the voice.

### 1-6. Modification of First Embodiment

The response process according to the first embodiment described above may have various modifications. A modification of the first embodiment will be described below.

For example, the response processing device 100 may periodically update the information stored in the agent table 32 or the command table 33. For example, in some cases the function of an agent 10 is expanded via a network. Specifically, in some cases an agent 10 having a “translation” function is updated, for example, to support a language that has not previously supported.

In this case, the response processing device 100 receives information indicating that the update has been performed, from the agent 10 in cooperation with the response processing device 100, and updates the information stored in the agent table 32 or the command table 33, on the basis of the received information. Thereby, the user can enjoy the benefit of the latest functions without regard for the update or the like of the functions of the plurality of agents 10.

### 2. Second Embodiment

### 2-1. Example of Response Process According to Second Embodiment

Next, a second embodiment will be described. In the example according to the first embodiment, the response processing device 100 outputs the results or the like of the response mainly by voice. In an example according to the second embodiment, the response processing device 100 outputs a result or the like of a response to the user by using means other than voice.

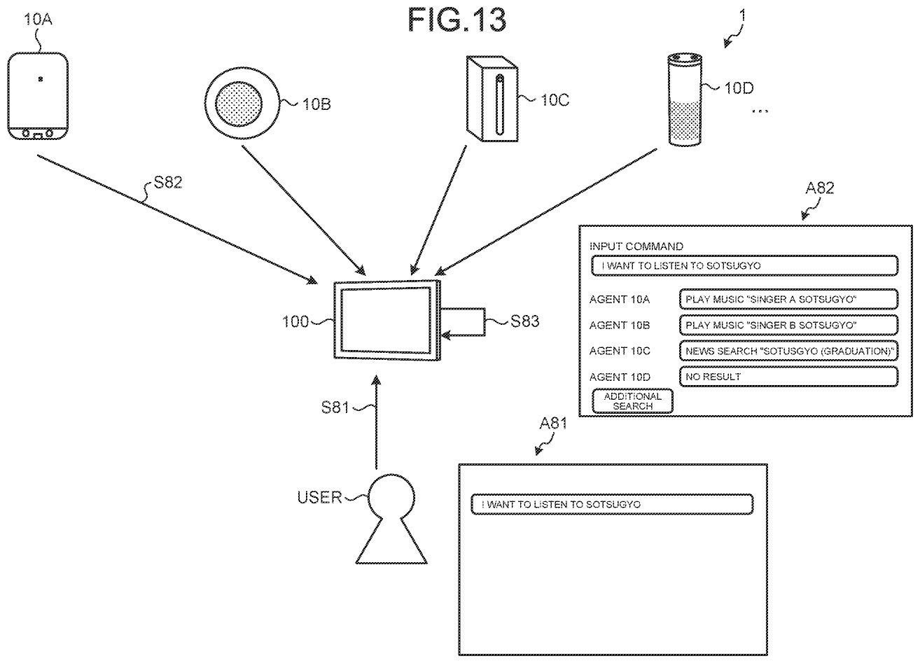

FIG. 13 is a diagram illustrating an example of a response process according to the second embodiment. FIG. 13 illustrates the example in which the user inputs input information by using the display of the response processing device 100 instead of voice, and the response processing device 100 presents the response by using the display instead of voice.

The user inputs the input information into the response processing device 100 via the touch panel or the like of the response processing device 100, first. The input information A81 illustrated in FIG. 13 shows that the user has input a text such as “I want to listen to “Sotsugyo””, on the display of the response processing device 100.

The user inputs the input information A81 to the response processing device 100 via an input operation or the like on the display (Step S81). As in the first embodiment, the response processing device 100 transmits a request for each agent 10 to generate the response, on the basis of the input information A81 (Step S82).

The response processing device 100 generates feedback A82 to be presented to the user, on the basis of the response acquired from each agent 10 (Step S83). The feedback A82 is displayed, for example, on the display of the response processing device 100. As illustrated in FIG. 13, the feedback A82 includes user interfaces such as buttons for requesting the content of the response generated by each agent 10 or requesting additional search.

As described above, the response processing device 100 according to the second embodiment may present the content of the response to the user by using screen display including the content of each of the responses generated by the plurality of agents 10, for the input information. This makes it possible for the response processing device 100 to, for example, flexibly present information according to the user's situation.

### 2-2. Variations of Response Process According to Second Embodiment

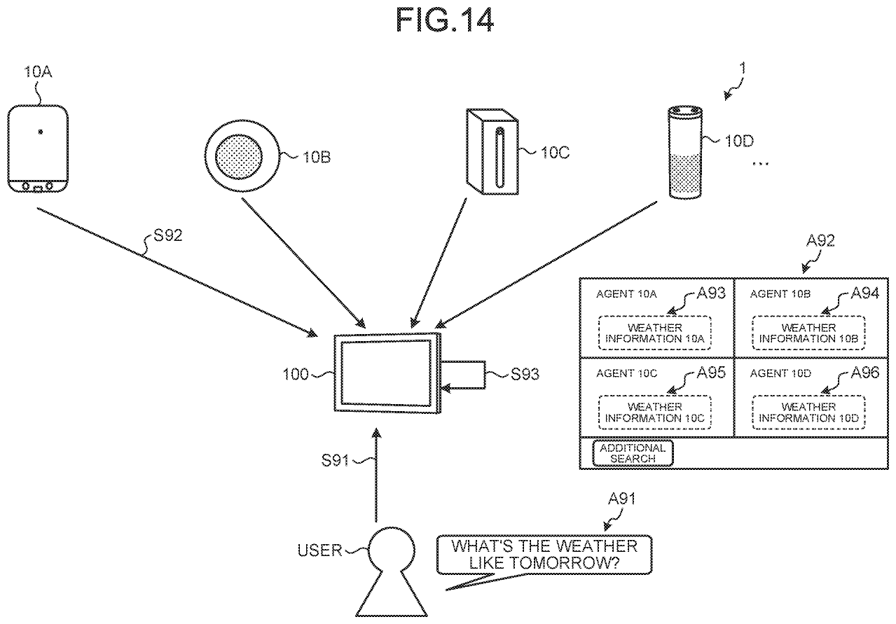

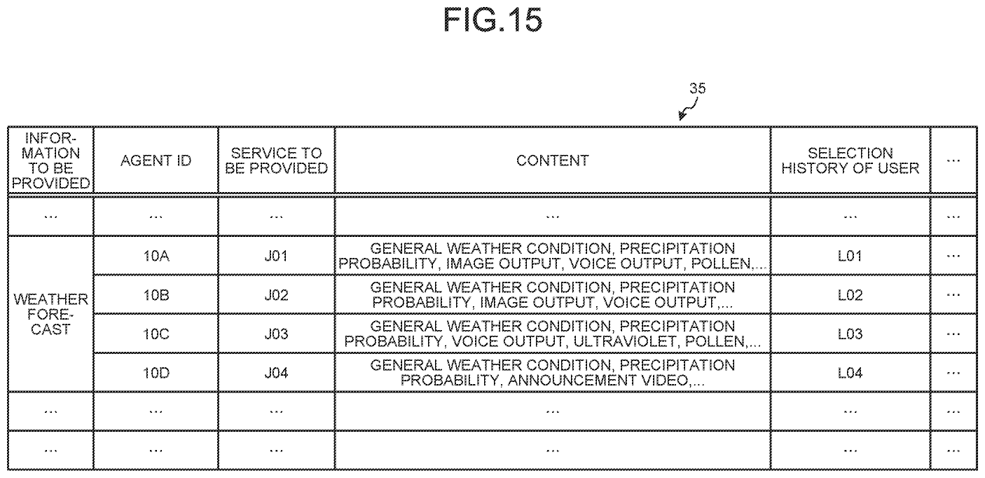

Next, a variation of the response processing according to the second embodiment will be described with reference to FIGS. 14 and 15. FIG. 14 is a diagram illustrating a first variation of the response process according to the second embodiment. The first variation of the information processing according to the second embodiment shows a situation in which, for example, the responses displayed by the response processing device 100 are changeable in display ratio on the basis of a predetermined condition.

FIG. 14 illustrates an example in which, for example, the user inputs, as input information A91, a question such as “What's the weather like tomorrow?” (Step S91). When receiving the input information A91, the response processing device 100 transmits a command corresponding to the input information A91 to each agent 10 and acquires the result of each response (Step S92).

Here, the respective agents 10 access different services (weather information services in this example) to acquire information, and it is assumed that the respective agents 10 generate different responses. The response processing device 100 acquires these responses and generates feedback A92 in which the respective responses are displayed (Step S93).

As illustrated in FIG. 14, the feedback A92 includes weather information A93 that represents a response generated by the agent 10A, weather information A94 that represents a response generated by the agent 10B, weather information A95 that represents a response generated by the agent 10C, and weather information A96 that represents a response generated by the agent 10D.

This makes it possible for the response processing device 100 to display a list of the responses generated by the respective agents 10, and thus, the results can be efficiently presented.

Furthermore, the response processing device 100 may change the ratio of the responses displayed in the feedback A92, on the basis of information of each agent 10 or information of each response.

In an example, the response processing device 100 determines a screen display ratio or area of the content of each response generated by each of the plurality of agents 10 for the input information, on the basis of a history indicating responses generated by the plurality of agents 10, selected by the user in the past.

For example, the response processing device 100 may increase a display area on the screen according to the frequency or rate of selection of an agent 10 by the user in the past. This makes it possible for the response processing device 100 to widely display information that the user prefers.

Furthermore, the response processing device 100 may determine the screen display ratio or area of the content of each response, according to amount of information of each of the responses generated by the plurality of agents 10 for the input information.

The above content will be described with reference to FIG. 15. FIG. 15 is a table illustrating an example of a database 35 according to the second embodiment. The database 35 is a database that stores the contents (amount of information) of the weather information acquired by each agent 10 and past selection history information of the user in association with each other.

As described above, the agent 10A, the agent 10B, the agent 10C, and the agent 10D acquire information from different services, and thereby, information transmitted to the response processing device 100 differs in spite of the same weather information. In other words, the response processing device 100 acquires different responses (weather information) from the agent 10A, agent 10B, agent 10C, and agent 10D.

For example, the database 35 illustrated in FIG. 15 shows information included in the responses acquired by the response processing device 100. Specifically, the example illustrated in FIG. 15 shows that the weather information acquired by the agent 10A is adaptable to “screen display”, “voice output”, and includes “precipitation probability” and “pollen information”, excluding “ultraviolet information”. In addition, the weather information acquired by the agent 10B is adaptable to “screen display” and “voice output”, includes “precipitation probability”, excluding “ultraviolet information” and “pollen information”.

In other words, the example illustrated in FIG. 15 shows that when the information provided by the agent 10 is “weather forecast”, for example, the agent 10A access the service “J01” and acquires information having the contents such as “general weather condition, precipitation probability, image output, voice output, pollen, . . . ” to perform weather forecast (i.e., acquire information about the weather forecast). Furthermore, the example shows that the user's history of selecting the response presented by the agent 10A when the user causes the response processing device 100 to execute the function of weather forecast is “L01”.

Note that In FIG. 15, “weather forecast” is shown as an example of information to be provided, but the information to be provided is not limited to this example, and, for example, “traffic information”, “news”, “restaurant search”, “TV program search”, “movie search”, “event search”, and the like may be provided.

The response processing device 100 acquires information in the database 35 from each agent 10 and generates the feedback A92 on the basis of, for example, the amount of information in the response. Specifically, the response processing device 100 increases the display ratio of an agent 10 that presents a response in which the weather information has a larger amount of information. Alternatively, the response processing device 100 may increase the display ratio of an agent 10 that has been selected by the user many times in the past.

For example, as illustrated in FIG. 14, when the responses about the weather information are generated by the plurality of agents 10, the response processing device 100 presents a response having a larger amount of information more widely on the screen. Alternatively, when the response processing device 100 refers to a history of conversation with the user and the history shows that the user has requested “pollen information” more than “ultraviolet information”, the response processing device 100 may presents weather information including the type of “pollen information” more widely on the screen. In other words, when the response processing device 100 has a plurality of responses, the response processing device 100 flexibly determines the form of the responses actually output to the user, according to the amount or type of the information of each response or the history or situation of the user in the past. This makes it possible for the response processing device 100 to output the response that meets the user's request more. Furthermore, the response processing device 100 is configured to present the responses acquired from a plurality of agents 10 by dynamically changing the display ratio thereof, thus providing the screen display that is not visually tiring.

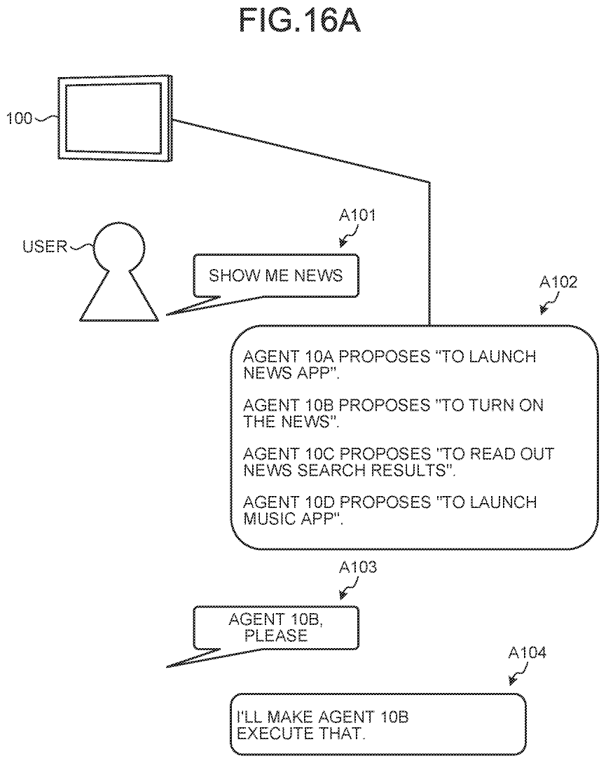

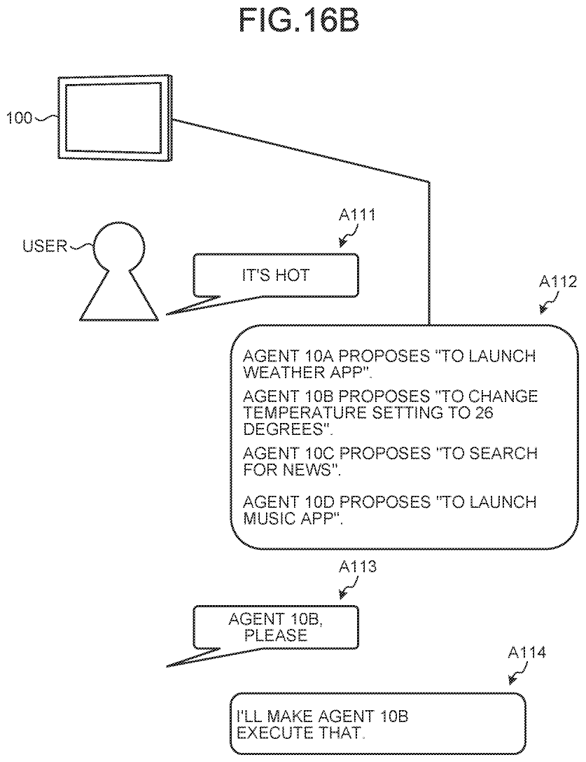

Next, different variations of the response process according to the second embodiment will be described with reference to FIGS. 16A and 16B. FIG. 16A is a diagram illustrating a second variation of the response process according to the second embodiment.

For example, FIG. 16A illustrates a situation in which the user inputs input information A101 based on voice such as “Show me news”, into the response processing device 100. In this case, the response processing device 100 generates a command corresponding to the voice such as “Show me news”, transmits the command to each agent 10, and acquires a response from each agent 10. Then, the response processing device 100 presents the response from each agent 10 to the user as feedback A102. Then, when the user issues a specific command A103 such as “Agent 10B, please”, the response processing device 100 outputs voice A104 such as “I'll make agent 10B execute that”, and causes the agent 10B to execute the content of the response proposed by the agent 10B.

In this way, the response processing device 100 is configured to present to the user various processes to be executed by each agent 10, on the basis of only one piece of the input information A101 received from the user. Therefore, for example, when the agents 10 are different home appliances, the user can cause one of the agents 10 to execute the process desired by the user without input of the command to a specific home appliance.

Next, an example of FIG. 16B will be described. FIG. 16B is a diagram illustrating a third variation of the response process according to the second embodiment.

For example, FIG. 16B illustrates a situation in which the user inputs input information A111 based on voice such as “It's hot”, into the response processing device 100. In this case, the response processing device 100 generates a command corresponding to the voice such as “It's hot”, transmits the command to each agent 10, and acquires a response from each agent 10. Then, the response processing device 100 presents the response from each agent 10 to the user as feedback A112. Then, when the user issues a specific command A113 such as “Agent 10B, please”, the response processing device 100 outputs voice A114 such as “I'll make agent 10B execute that”, and causes the agent 10B to execute the content of the response proposed by the agent 10B.

In this case as well, as in the example of FIG. 16A, the response processing device 100 is configured to present to the user various processes to be executed by each agent 10, on the basis of only one piece of the input information A111 received from the user. Therefore, the user can efficiently select a process desired by the user.

Note that the response processing device 100 is operable to perform processing in cooperation with a so-called smart home appliance, in addition to the information devices illustrated in FIGS. 16A and 16B. For example, when the response processing device 100 receives the input information such as “What foodstuff is contained?” or “What food is likely to expire?” from the user, the response processing device 100 transmits the command to an agent 10 mounted on a refrigerator. Then, the response processing device 100 presents information acquired from a log indicating user's use, product tag, or the like to the user, as the response from the agent 10.

Alternatively, when the response processing device 100 receives the input information such as “Did I lock the door?” or “Please lock the door”, from the user, the response processing device 100 transmits the command to an agent 10 mounted to a smart key. Then, the response processing device 100 presents to the user a response such as information about a locking state of home or locking of the door, as the response from the agent 10. Alternatively, when the response processing device 100 receives the input information such as “Turn on the light in the living room”, or “Turn on the light in the bedroom”, from the user, the response processing device 100 transmits the command to an agent 10 mounted to a lamp. Then, the response processing device 100 presents to the user a response such as turning on the light in home, as the response from the agent 10. In this way, the response processing device 100 is operable to perform the response process useful for the user, in cooperation with not only the information device such as the smart speaker but also various information devices.

### 3. Other Embodiments

The processes according to the embodiments descried above may be carried out in various different forms other than that in the embodiments described above.

### 3-1. Variation of Response Output

For example, when all agents 10 that are in cooperation with each other generate responses having the same content, the response processing device 100 may cause any of the agents 10 to output the response without presenting the responses to the user.

### 3-2. Timing to Transmit User's Reaction

The response processing device 100 may transmit the user's reaction after a predetermined time period, without transmitting the user's reaction to the agents 10 immediately after the user selects any of a plurality of responses presented.

In other words, the response processing device 100 determines whether the user enjoys a service, waits for a time period long enough to assume that the user enjoys the service, and then transmits the user's reaction to each agent 10. This makes it possible for the response processing device 100 to accurately feedback information of the response selected by the user to each agent 10, even if the user selects a response by mistake or even in a situation where the user desires a different response in fact. Note that the response processing device 100 may accept registration from the user about timing at which the feedback is transmitted to each agent 10.

### 3-3. Device Configuration

The embodiments described above show the example in which the response processing device 100 is the so-called smartphone or tablet device and performs the process in a stand-alone manner. However, the response processing device 100 may perform the response processing according to the present disclosure in cooperation with a server device (so-called cloud server, etc.) connected via a network. In this configuration, the terminal such as the smartphone or tablet device functions as an interface mainly performing a conversation process with the user, such as a process of collecting the user's speech, a process of transmitting the collected speech to the server device, and a process of outputting voice transmitted from the server device.

Furthermore, the response processing device according to the present disclosure may be achieved as a form of an IC chip or the like mounted in the smartphone or tablet device instead of an independent device.

Furthermore, of the processes described in the embodiments described above, all or part of processes which are described to be automatically performed can be performed manually, or all or part of the process described to be performed manually can be performed automatically by a known method. In addition, the process procedures, specific names, and information including various data and parameters, which are shown in the above description or the drawings can be appropriately changed unless otherwise specified. For example, various information illustrated in the drawings is not limited to the information illustrated.

In addition, the component elements of the devices are illustrated as functional concepts and are not necessarily required to be physically configured as illustrated. In other words, the specific forms of distribution or integration of the devices are not limited to those illustrated, and all or part thereof can be configured by functionally or physically distributed or integrated in any units, according to various loads or usage conditions. For example, the analysis unit 51 and the generation unit 52 may be integrated with each other.

Furthermore, the embodiments and modifications described above can be appropriately combined within a range consistent with the contents of the process.

Furthermore, the effects described herein are merely examples and not limited, and other effects may also be provided.

### 4. Effects of Response Processing Device According to Present Disclosure

As described above, the response processing device (the response processing device 100 in the embodiments) according to the present disclosure includes the reception unit (the reception unit 40 in the embodiments), the presentation unit (presentation unit 50 in the embodiments), and the transmission unit (the transmission unit 54 in the embodiments). The reception unit receives the input information being information that triggers generation of the response by each information device (each agent 10 in the embodiments). The presentation unit presents to the user the responses generated for the input information by a plurality of the information devices. The transmission unit transmits the user's reaction to the presented responses, to the plurality of the information devices.

As described above, the response processing device according to the present disclosure plays the role of mediation, for example, behaves as the front-end device for the plurality of the information devices, presents a plurality of the responses to the user, and transmits a result selected by the user to the information devices. This makes it possible for the response processing device to reduce the effort to have a conversation between the user and each of the plurality of information devices, when the user uses the plurality of information devices, and thereby improving the convenience of the user.

Furthermore, the presentation unit controls an information device that has generated a response selected by the user from the presented responses to output the selected response. This makes it possible for the response processing device to control the response desired by the user to be output from the information device selected by the user.

Furthermore, the presentation unit acquires the response selected from the presented responses by the user, from the information device that has generated the selected response, and outputs the acquired response. This makes it possible for the response processing device to output the response desired by the user instead of the information device that is, for example, installed at a position relatively distant from the user, improving the convenience of the user.

Furthermore, after any of the presented responses is output, the reception unit accepts a command indicating change of the response to be output, from the user. The presentation unit changes the response being output to a different response on the basis of the command. This makes it possible for the response processing device to present the different response to the user with a simple operation without repeating the first conversation with the user, improving the convenience of the user.

Furthermore, when the responses generated by the plurality of information devices to the input information include the same content, the presentation unit collectively presents the responses including the same content. This makes it possible for the response processing device to avoid a situation in which the responses having the same content are output to the user many times.

In addition, the reception unit accepts the command requesting a different response to the presented response, from the user. The transmission unit transmits the request for additional search with respect to the input information, to the plurality of information devices, on the basis of the command. This makes it possible for the response processing device to cause the information devices to quickly perform the additional search even if the response desired by the user is not generated.

Furthermore, the presentation unit outputs, to the user, one response selected from the responses generated for the input information by the plurality of information devices, on the basis of the history indicating responses generated by the plurality of information devices, selected by the user in the past. This makes it possible for the response processing device to output a response without explicit selection by the user, reducing the user's time and effort.

In addition, the transmission unit transmits, as the user's reaction, information about a response selected by the user from the presented responses, to the plurality of information devices. This makes it possible for the response processing device to transmit a plurality of positive examples and negative examples to the plurality of information devices in a single conversation, enabling efficient learning of the information devices.

Furthermore, the transmission unit transmits, as the information about a response selected by the user, the content of the response selected by the user or the identification information of the information device that has generated the response selected by the user, to the plurality of information devices. This makes it possible for the response processing device to provide specific information about what kind of response the user desires, to the information devices.

Furthermore, the transmission unit transmits, as the user's reaction, information indicating that none of the presented responses has been selected by the user, to the plurality of information devices. This makes it possible for the response processing device to collectively transmit information that the user does not desire, to the information devices, avoiding a situation in which the information that the user does not desire is presented to the user many times.

Furthermore, the transmission unit transmits the contents of the responses to the plurality of information devices together with information indicating that none of the presented responses has been selected by the user. This makes it possible for the response processing device to collectively transmit information that the user does not desire, to the information devices, avoiding a situation in which the information that the user does not desire is presented to the user many times.

Furthermore, the presentation unit performs presentation for the user by using voice containing the contents of the responses generated for the input information by the plurality of information devices. This makes it possible for the response processing device to present the plurality of responses to the user in an easy-to-understand manner.

Furthermore, the presentation unit performs presentation for the user by using screen display containing the contents of the responses generated for the input information by the plurality of information devices. This makes it possible for the response processing device to present the plurality of responses to the user at once without using voice.

In addition, the presentation unit determines the screen display ratio or area of the content of each response generated by each of the plurality of information devices for the input information, on the basis of the history indicating responses generated by the plurality of information devices, selected by the user in the past. This makes it possible for the response processing device to present the information expected to be desired by the user to the user in a highly visible state, improving the usability of the response process.

Furthermore, the presentation unit determines the screen display ratio or area of the content of each response, according to the amount of information of each of the responses generated by the plurality of information devices for the input information. This makes it possible for the response processing device to present a response having a larger amount of information to the user in a highly visible state, improving the usability of the response process.

In addition, the reception unit receives the voice information from the user, as the input information. This makes it possible for the response processing device to have an appropriate conversation according to the user's situation, in voice communication with the user.

In addition, the reception unit receives the text input by the user, as the input information. This makes it possible for the response processing device to present an appropriate response corresponding to the text input by the user without the user's speech.

### 5. Hardware Configuration

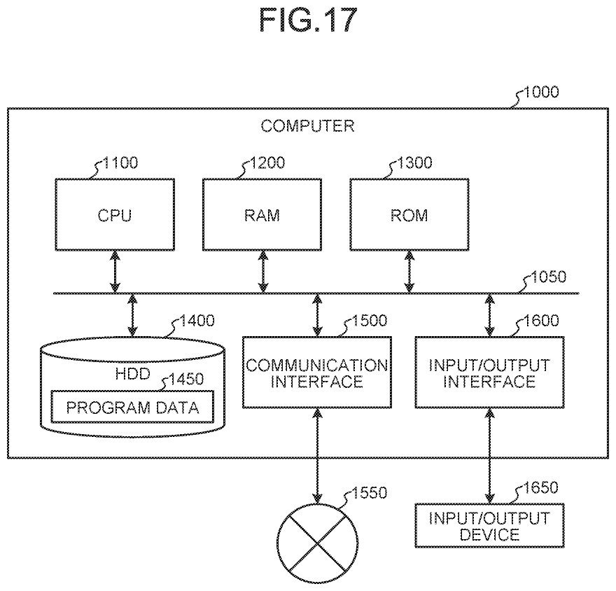

The information devices such as the response processing device 100, the agents 10, and the external server 200 according to the embodiments described above are achieved by, for example, a computer 1000 having a configuration as illustrated in FIG. 17. Hereinafter, an example of the response processing device 100 according to the first embodiment will be described. FIG. 17 is a hardware configuration diagram illustrating an example of the computer 1000 configured to achieve the functions of the response processing device 100. The computer 1000 includes a CPU 1100, a RAM 1200, a read only memory (ROM) 1300, a hard disk drive (HDD) 1400, a communication interface 1500, and an input/output interface 1600. The component units of the computer 1000 are connected by a bus 1050.

The CPU 1100 is operated on the basis of a program stored in the ROM 1300 or the HDD 1400 and controls each unit. For example, the CPU 1100 deploys programs stored in the ROM 1300 or the HDD 1400 on the RAM 1200 and executes processing corresponding to various programs.

The ROM 1300 stores a boot program such as a basic input output system (BIOS) executed by the CPU 1100 when the computer 1000 is booted, a program depending on hardware of the computer 1000, and the like.

The HDD 1400 is a computer-readable recording medium that non-transitorily records programs executed by the CPU 1100, data used by the programs, and the like. Specifically, the HDD 1400 is a recording medium that records the response processing program according to the present disclosure, the response processing program being an example of program data 1450.

The communication interface 1500 is an interface that connects the computer 1000 to an external network 1550 (e.g., the Internet). For example, the CPU 1100 receives data from another device or transmits data generated by the CPU 1100 to another device via the communication interface 1500.

The input/output interface 1600 is an interface that connects an input/output device 1650 to the computer 1000. For example, the CPU 1100 receives data from an input device such as a keyboard or mouse via the input/output interface 1600. In addition, the CPU 1100 transmits data to an output device such as a display, speaker, or printer via the input/output interface 1600. Furthermore, the input/output interface 1600 may function as a media interface that reads a program or the like recorded on a predetermined recording medium. The medium includes, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, when the computer 1000 functions as the response processing device 100 according to the first embodiment, the CPU 1100 of the computer 1000 achieves the functions of the reception unit 40 and the like by executing the response processing program loaded on the RAM 1200. Furthermore, the HDD 1400 stores the response processing program according to the present disclosure or data in the storage unit 30. Note that the CPU 1100 executes the program data 1450 read from the HDD 1400, but in another example, the CPU 1100 may acquire these programs from another device via the external network 1550.

Note that the present technology may also employ the following configurations.

(1)

A response processing device comprising:

a reception unit configured to receive input information being information that triggers generation of a response by an information device;

a presentation unit configured to present to a user each of the responses generated by a plurality of the information devices for the input information; and

a transmission unit configured to transmit user's reaction to the presented responses, to the plurality of information devices.

(2)

The response processing device according to (1), wherein

the presentation unit

controls an information device that has generated a response selected by the user from the presented responses to output the selected response.

(3)

The response processing device according to (1) or (2), wherein

the presentation unit

acquires a response selected by the user from the presented responses, from an information device that has generated the selected response, and outputs the acquired response.

(4)

The response processing device according to any one of (1) to (3), wherein

the reception unit

after any of the presented responses is output, accepts a command indicating change of the response to be output, from the user, and

the presentation unit

changes the response being output to a different response, based on the command.

(5)

The response processing device according to any one of (1) to (4), wherein

the presentation unit

when responses generated by the plurality of information devices to the input information include the same content, collectively presents the responses including the same content.

(6)

The response processing device according to any one of (1) to (5), wherein

the reception unit

accepts a command requesting a different response to the presented response, from the user, and

the transmission unit

transmits a request for additional search with respect to the input information, to the plurality of information devices, based on the command.

(7)

The response processing device according to any one of (1) to (6), wherein

the presentation unit

outputs, to the user, one response selected from the responses generated for the input information by the plurality of information devices, based on a history indicating responses generated by the plurality of information devices, selected by the user in the past.

(8)

The response processing device according to any one of (1) to (7), wherein

the transmission unit

transmits, as the user's reaction, information about a response selected by the user from the presented responses, to the plurality of information devices.

(9)

The response processing device according to (8), wherein

the transmission unit

transmits, as the information about the response selected by the user, a content of the response selected by the user or identification information of an information device that has generated the response selected by the user, to the plurality of information devices.

(10)

The response processing device according to any one of (1) to (9), wherein

the transmission unit

transmits, as the user's reaction, information indicating that none of the presented responses has been selected by the user, to the plurality of information devices.

(11)

The response processing device according to (10), wherein

the transmission unit

transmits contents of the presented responses to the plurality of information devices, together with information indicating that none of the presented responses has been selected by the user.

(12)

The response processing device according to any one of (1) to (11), wherein

the presentation unit

performs presentation for the user by using voice containing contents of the responses generated for the input information by the plurality of information devices.

(13)

The response processing device according to any one of (1) to (12), wherein

the presentation unit

performs presentation for the user by using screen display containing contents of the responses generated for the input information by the plurality of information devices.

(14)

The response processing device according to (13), wherein

the presentation unit

determines a screen display ratio or area of the content of each response generated by each of the plurality of information devices for the input information, based on a history indicating responses generated by the plurality of information devices, selected by the user in the past.

(15)

The response processing device according to (13) or (14), wherein

the presentation unit

determines a screen display ratio or area of the content of each response, according to an amount of information of each of the responses generated by the plurality of information devices for the input information.

(16)

The response processing device according to any one of (1) to (15), wherein

the reception unit

receives voice information from the user, as the input information.

(17)

The response processing device according to any one of (1) to (16), wherein

the reception unit

receives a text input by the user, as the input information.

(18)

A response processing method, by a computer, comprising:

receiving input information being information that triggers generation of a response by an information device;

presenting to a user each of the responses generated by a plurality of the information devices for the input information;

and transmitting user's reaction to the presented responses, to the plurality of information devices.

(19)

A response processing program causing a computer to function as:

a reception unit configured to receive input information being information that triggers generation of a response by an information device;

a presentation unit configured to present to a user each of the responses generated by a plurality of the information devices for the input information; and

a transmission unit configured to transmit user's reaction to the presented responses, to the plurality of information devices.

### REFERENCE SIGNS LIST

1 RESPONSE PROCESSING SYSTEM
10 AGENT
100 RESPONSE PROCESSING DEVICE
20 SENSOR
20A VOICE INPUT SENSOR
20B IMAGE INPUT SENSOR
21 INPUT UNIT
22 COMMUNICATION UNIT
30 STORAGE UNIT
31 USER INFORMATION TABLE
32 AGENT TABLE
33 COMMAND TABLE
34 HISTORY TABLE
40 RECEPTION UNIT
41 DETECTION UNIT
42 REGISTRATION UNIT
43 ACQUISITION UNIT
50 PRESENTATION UNIT
51 ANALYSIS UNIT
52 GENERATION UNIT
53 OUTPUT CONTROL UNIT
54 TRANSMISSION UNIT
60 OUTPUT UNIT
200 EXTERNAL SERVER

1. A response processing device comprising:
a reception unit configured to receive input information being information that triggers generation of a response by an information device;
a presentation unit configured to present to a user each of the responses generated by a plurality of the information devices for the input information; and
a transmission unit configured to transmit user's reaction to the presented responses, to the plurality of information devices.

2. The response processing device according to claim 1, wherein
the presentation unit
controls an information device that has generated a response selected by the user from the presented responses to output the selected response.

3. The response processing device according to claim 1, wherein
the presentation unit
acquires a response selected by the user from the presented responses, from an information device that has generated the selected response, and outputs the acquired response.

4. The response processing device according to claim 1, wherein
the reception unit
after any of the presented responses is output, accepts a command indicating change of the response to be output, from the user, and
the presentation unit
changes the response being output to a different response, based on the command.

5. The response processing device according to claim 1, wherein
the presentation unit
when responses generated by the plurality of information devices to the input information include the same content, collectively presents the responses including the same content.

6. The response processing device according to claim 1, wherein
the reception unit
accepts a command requesting a different response to the presented response, from the user, and
the transmission unit
transmits a request for additional search with respect to the input information, to the plurality of information devices, based on the command.

7. The response processing device according to claim 1, wherein
the presentation unit
outputs, to the user, one response selected from the responses generated for the input information by the plurality of information devices, based on a history indicating responses generated by the plurality of information devices, selected by the user in the past.

8. The response processing device according to claim 1, wherein
the transmission unit
transmits, as the user's reaction, information about a response selected by the user from the presented responses, to the plurality of information devices.

9. The response processing device according to claim 8, wherein
the transmission unit
transmits, as the information about the response selected by the user, a content of the response selected by the user or identification information of an information device that has generated the response selected by the user, to the plurality of information devices.

10. The response processing device according to claim 1, wherein
the transmission unit
transmits, as the user's reaction, information indicating that none of the presented responses has been selected by the user, to the plurality of information devices.

11. The response processing device according to claim 10, wherein
the transmission unit
transmits contents of the presented responses to the plurality of information devices, together with information indicating that none of the presented responses has been selected by the user.

12. The response processing device according to claim 1, wherein
the presentation unit
performs presentation for the user by using voice containing contents of the responses generated for the input information by the plurality of information devices.

13. The response processing device according to claim 1, wherein
the presentation unit
performs presentation for the user by using screen display containing contents of the responses generated for the input information by the plurality of information devices.

14. The response processing device according to claim 13, wherein
the presentation unit
determines a screen display ratio or area of the content of each response generated by each of the plurality of information devices for the input information, based on a history indicating responses generated by the plurality of information devices, selected by the user in the past.

15. The response processing device according to claim 13, wherein
the presentation unit
determines a screen display ratio or area of the content of each response, according to an amount of information of each of the responses generated by the plurality of information devices for the input information.

16. The response processing device according to claim 1, wherein
the reception unit
receives voice information from the user, as the input information.

17. The response processing device according to claim 1, wherein
the reception unit
receives a text input by the user, as the input information.

18. A response processing method, by a computer, comprising:
receiving input information being information that triggers generation of a response by an information device;
presenting to a user each of the responses generated by a plurality of the information devices for the input information; and
transmitting user's reaction to the presented responses, to the plurality of information devices.
